(19) United States
(12) Patent Application Publication
(10) Pub. No.: US 2026/0253166 A1
(43) Pub. Date: Aug. 27, 2026

(54) GRAPHICS PROCESSING SYSTEMS

(71) Applicant: Arm Limited, Cambridge (GB)

(72) Inventors: Frank Klaeboe Langtind, Melhus (NO); Harsh Ashok Gugale, Austin, TX (US); Philip Carlos Garcia, Austin, TX (US)

(73) Assignee: Arm Limited, Cambridge (GB)

(21) Appl. No.: 19/065,911

(22) Filed: Feb. 27, 2025

(51) Int. Cl. G06T 1/20; G06T 1/60

(52) U.S. Cl. CPC G06T 1/20; G06T 1/60

(57) ABSTRACT

In a graphics processor that is configured to execute a tile-based graphics processing pipeline a geometry buffer is provided that is operable to store ‘temporary’ geometry items that are produced by and then consumed during the initial, geometry processing pass of the tile-based graphics processing pipeline. Allocations to the geometry buffer are controlled to keep the active size of the geometry below a certain threshold.

### BACKGROUND

The technology described herein relates to graphics processing, and in particular to tile-based graphics processing.

Graphics processing is normally carried out by first splitting a scene (e.g. a 3D model) to be rendered (e.g. for display) into a number of similar basic components or “primitives”, which primitives are then subjected to the desired graphics processing operations. The graphics primitives are usually in the form of simple polygons such as triangles, quadrilaterals, points, lines or groups thereof.

Each primitive is usually defined by and represented as a set of vertices (e.g. three vertices in the case of a triangular primitive). The vertices that are to be used for the primitives will have respective sets of vertex data defining the vertices, e.g. the relevant attributes for each of the vertices. These attributes will typically include position data and other, non-position data (varyings), e.g. defining colour, light, normal, texture coordinates, etc., for the vertex in question.

In tile-based graphics processing, the two-dimensional graphics processing (render) output (i.e. the output of the rendering process, such as an output frame to be displayed) is generated (rendered) as a plurality of smaller area regions, usually referred to as “tiles”. The render output is typically divided (by area) into regularly-sized and shaped rendering tiles (they are usually e.g. squares or rectangles). The tiles are each rendered separately (e.g. one after another). The rendered tiles are then combined to provide the complete render output (e.g. frame for display).

When performing tile-based graphics processing, there will normally be some initial geometry processing, such as vertex processing (vertex shading) of attributes for vertices to be used for primitives for the render output being generated, to generate geometry (and other) data required for rendering the graphics processing output.

The geometry processing will then be followed by a tiling/binning process that generates appropriate data structures for determining which geometry (e.g. primitives) needs to be processed for respective rendering tiles of the output being generated. For instance, in tile-based graphics processing, it is usually desirable to be able to (try to) identify the geometry (e.g. primitives) for the render output that need to be processed for a given rendering tile, so as to avoid unnecessarily processing geometry that does not actually apply to a rendering tile. To facilitate this, a tiling/binning process is performed that effectively sorts the geometry relative to the rendering tiles.

Once the binning/tiling process has generated the necessary data structures for identifying geometry to be processed for respective tiles of the render output, the geometry can then be, and will be, subjected to appropriate rendering/fragment processing. This may comprise, for example, rasterising primitives to be processed to fragments, fragment shading of the fragments, and/or performing ray tracing operations. The rendering/fragment processing operation is performed on a tile-by-tile basis, using the data structures generated by the tiling/binning process to identify the geometry (e.g. primitives) that need to be processed for a respective rendering tile.

The rendered tiles may then be combined appropriately to provide the overall render output (e.g. frame for display).

The Applicant believes that there remains scope for improvements to the operation of tile-based graphics processors.

### BRIEF DESCRIPTION OF THE DRAWINGS

Embodiments of the technology described herein will now be described by way of example only and with reference to the accompanying drawings, in which:

FIG. 1 shows an exemplary data processing system in which the technology described herein may be implemented;

FIG. 2 shows an exemplary graphics processing pipeline;

FIG. 3 shows schematically a graphics processor that may be operated in accordance with the technology described herein;

FIG. 4, FIG. 5 and FIG. 6 illustrate aspects of a memory management operation for a geometry buffer according to an embodiment;

FIG. 7 illustrates the memory management operation when the partitioning of the geometry buffer is changed;

FIG. 8 is a flow chart illustrating the memory management operation when allocating portions of memory; and

FIG. 9 is a flow chart illustrating the corresponding memory management operation when deallocating portions of memory.

Like reference numerals are used for like features in the Figures, where appropriate.

### DETAILED DESCRIPTION

A first embodiment of the technology described herein comprises a data processing system comprising a graphics processor that is configured to execute a tile-based graphics processing pipeline in which a render output is generated by performing an initial, “geometry processing” pass and a subsequent, “rendering” pass,
wherein the initial, geometry processing pass of the graphics processing pipeline being executed by the graphics processor comprises:
a sequence of one or more geometry processing stages to perform geometry processing; and
a binning stage to generate data structures for identifying geometry to be processed when rendering respective tiles of a render output being generated, and
wherein the subsequent, rendering pass of the graphics processing pipeline being executed by the graphics processor comprises a rendering stage to render respective (render output) tiles,
the data processing system further comprising:
a geometry buffer for storing (temporary) geometry items that are produced by the sequence of one or more geometry processing stages and then consumed during the initial, geometry processing pass,
the graphics processor further comprising access logic for controlling access to the geometry buffer,
wherein the geometry buffer is configured as a set of memory pools that can be allocated to respective geometry processing stages for storing the geometry items produced thereby, and wherein the access logic is operable and configured to track a total amount of memory that is currently allocated (i.e. is ‘active’) for storing geometry items across the set of memory pools, and
wherein the access logic is operable to, for a request to allocate a respective portion of a memory pool in the set of memory pools for storing a new geometry item produced by the respective geometry processing stage to which the memory pool is allocated:
determine, based on the tracking, whether allocating the requested portion of the memory pool would cause the total amount of memory allocated for storing geometry items across the set of memory pools to exceed a permitted active size threshold for the geometry buffer; and
when it is determined that allocating the requested portion of the memory pool would cause the total amount of memory allocated for storing geometry items across the set of memory pools to exceed the permitted active size threshold for the geometry buffer, prevent the allocation being made.

A second embodiment of the technology described herein comprises a method of operating a data processing system,
wherein the data processing system comprises a graphics processor that is configured to execute a tile-based graphics processing pipeline in which a render output is generated by performing an initial, “geometry processing” pass and a subsequent, “rendering” pass,
wherein the initial, geometry processing pass of the graphics processing pipeline being executed by the graphics processor comprises:
a sequence of one or more geometry processing stages to perform geometry processing; and
a binning stage to generate data structures for identifying geometry to be processed when rendering respective tiles of a render output being generated, and
wherein the subsequent, rendering pass of the graphics processing pipeline being executed by the graphics processor comprises a rendering stage to render respective (render output) tiles,
the data processing system further comprising:
a geometry buffer for storing (temporary) geometry items that are produced by the sequence of one or more geometry processing stages and then consumed during the initial, geometry processing pass,
wherein the geometry buffer is configured as a set of memory pools that can be allocated to respective geometry processing stages for storing the geometry items produced thereby, and wherein the method comprises:
tracking a total amount of memory that is currently allocated for storing geometry items across the set of memory pools, and
for a request to allocate a respective portion of a memory pool in the set of memory pools for storing a new geometry item produced by the respective geometry processing stage to which the memory pool is allocated:
determining, based on the tracking, whether allocating the requested portion of the memory pool would cause the total amount of memory allocated for storing geometry items across the set of memory pools to exceed a permitted active size threshold for the geometry buffer; and
when it is determined that allocating the requested portion of the memory pool would cause the total amount of memory allocated for storing geometry items across the set of memory pools to exceed the permitted active size threshold for the geometry buffer, preventing the allocation being made.

The technology described herein relates generally to graphics processors that are operable and configured to perform so-called “tile-based” rendering in which a render output (e.g. frame) to be generated is subdivided for the purposes of rendering into a plurality of smaller-area rendering “tiles”. Each rendering tile can then be, and typically is, rendered separately.

To facilitate this, in tile-based rendering, a render pass is effectively split into two separate processing passes, namely an initial, “geometry processing” pass that executes the geometry related processing including the geometry binning, and generates appropriate data structures for determining which geometry needs to be processed for respective rendering tiles of the output being generated, and a subsequent, (deferred) “rendering” pass that renders respective rendering tiles of the render output.

The deferred rendering pass executes the rendering/fragment processing on a tile-by-tile basis and writes the rendered tiles back to memory once the rendering/fragment processing has been completed.

The graphics processor will thus include suitable processing circuits for implementing the various (different) stages of the tile-based graphics processing pipeline that is to be executed, which stages will include a set of one or more geometry processing stages (to perform geometry processing), a binning stage (to generate the data structures for determining which geometry needs to be processed for respective rendering tiles of the output being generated, the geometry processing stages and the binning stage thus together constituting the initial, “geometry processing” pass), and a rendering stage (to render the respective tiles during the subsequent, “rendering” pass).

These stages are further arranged in a “pipelined” manner that defines the particular sequence of processing operations to be performed when generating a render output, and hence the corresponding data ‘flow’.

For instance, in embodiments, as will be described below, the geometry processing stages of the graphics processing pipeline that is executed by the graphics processor perform processing for “packets” of geometry, e.g., and in embodiments, such that the geometry processing stages (prior to the binning stage) operate to produce respective “packets” of (processed) geometry, each packet storing data for geometry to be further processed by the graphics processor.

The end result of the geometry processing performed by the sequence of geometry processing stages may thus be, and in embodiments is, to produce respective geometry packets for storing appropriate geometry data, such as (transformed) vertex positions, vertex varyings, and primitive attributes, which geometry data will then be used, for example, by the rendering/fragment processing of the later stages of the tile-based graphics processing pipeline.

The geometry data that has been completely processed by the set of one or more geometry processing stages and that may be used by the rendering/fragment processing stage may be referred to as “intermediate” geometry data. This intermediate geometry data may thus be written out, e.g., by the final geometry stage in the set of one or more geometry processing stages, and/or by the binning stage, to appropriate storage, e.g. in (main) memory, so that this intermediate geometry data can then be used, as needed, for the rendering/fragment processing of the later stages of the tile-based graphics processing pipeline.

In this respect, it will be appreciated that a large number of intermediate geometry items may be produced, and this intermediate geometry data may need to be stored for the entire duration of a render pass (i.e. until the current render pass has completed), so appropriate (e.g. external) storage needs to be provided to be able to handle this.

In the tile-based graphics processing pipeline that is executed by the graphics processor according to the technology described herein, there will also be various “temporary” geometry data that is produced by the geometry processing stages, but that will also be consumed during the initial, geometry processing pass. This “temporary” geometry data will correspondingly therefore have a much shorter lifetime than the so-called “intermediate” geometry data discussed above that is the end result of the initial, geometry processing pass.

For instance, a given input packet that is provided to a particular geometry processing stage within the geometry processing stages of the graphics processing pipeline may be further processed within that geometry processing stage to generate zero or more output packets, which output packets may in turn be passed to a next geometry processing stage for processing.

So, for example, a vertex shading stage will in embodiments receive an input set of vertices that have been defined for a render output and process these to produce a processed vertex packet containing corresponding processed (shaded) vertex data, etc. The vertex packet may then be provided to a next geometry processing stage for further processing (which next geometry processing stage may, e.g., be a tessellation or geometry shader stage, depending on the particular sequence of geometry processing operations that is to be performed), and so on.

Various arrangements are possible in this regard, e.g. depending on the particular geometry processing pipeline that is to be supported, and in general the geometry items that are processed/produced by the geometry processing stages may take any suitable and desired form.

Correspondingly, as will be explained further below, the binning stage in embodiments then processes the geometry items (e.g. packets) produced by the geometry processing stages, or at least processes data structures (e.g. bounding boxes) associated with or derived from these geometry items, to thereby generate the appropriate data structures for identifying which primitives are to be processed when rendering which respective tiles of the render output being generated.

Thus, in the tile-based graphics processing pipeline that is executed by the graphics processor according to the technology described herein, the initial, geometry processing pass that is performed for a particular render output will produce various “temporary” geometry items, i.e. geometry items that are produced by the geometry processing stages during the processing of data for a particular render output, but which geometry items will be subsequently consumed during the same initial, geometry processing pass. These temporary geometry items may, for example, include geometry items that are produced by one geometry processing stage that are then consumed by another, later geometry processing stage, and/or geometry items that are consumed by the binning stage.

These “temporary” geometry items may therefore need to be temporarily stored, as they should remain available to the graphics processor until any and all further processing that uses them has completed.

These “temporary” geometry items, however, do not constitute part of the final (rendered) output data generated by the graphics processor and are instead consumed during the initial, geometry processing pass.

Accordingly, these temporary geometry items can be discarded once the processing during the initial, geometry processing pass that uses these temporary geometry items has completed (and so this is different to the “intermediate” geometry data that is written out at the end of the initial, geometry processing pass and that may also be used during the subsequent, rendering pass and so may need to be stored for the entire duration of the render pass).

The graphics processor of the technology described herein thus also has access to suitable storage in the form of a “geometry buffer” that is operable to store such (temporary) geometry items that are produced by the sequence of one or more geometry processing stages and that will also be consumed during the initial, geometry processing pass.

In embodiments, this storage is dedicated for storing such (temporary) geometry items that are produced by the sequence of one or more geometry processing stages and that will also be consumed during the initial, geometry processing pass (and so it is in embodiments different and separate to any storage that is used for storing the “intermediate” geometry data that needs to be stored for the duration of the render pass, for instance).

According to the technology described herein, this storage (the geometry buffer) is configured as a set of one or more memory pools that are operable to store (temporary) geometry items that are produced by the sequence of one or more geometry processing stages and that will also be consumed during the initial, geometry processing pass.

Thus, the set of one or more memory pools can be, and in embodiments are, allocated appropriately to the sequence of one or more geometry processing stages for storing corresponding (temporary) geometry items that are produced by the sequence of one or more geometry processing stages and that will also be consumed during the initial, geometry processing pass.

A memory pool that has been allocated to one or more of the geometry processing stages within the sequence of geometry processing stages is thus generally operable to store the (temporary) geometry items that are to be produced and/or processed by those geometry processing stages.

For example, where the geometry processing stages are operable and configured to process/produce “packets” of geometry, as described above, a memory pool allocated to the sequence of geometry processing stages will be effectively divided into such packets. Thus, a memory pool that has been allocated to a vertex shading stage may be, and in embodiments is, operable to store shaded vertex packets produced by that stage. The vertex shading stage when a new packet is to be produced may thus allocate a respective portion of the memory pool allocated to the vertex shading stage for storing the shaded vertex data for that packet. A later processing stage may then access that packet and generate one or more further packets, for which appropriate space may be allocated in a respective memory pool allocated for the later processing stage, etc. At some point, once the packet has been consumed, e.g. by the last geometry processing stage that will use that packet, the allocated space for that packet can be deallocated, such that space is made available for storing new packets.

In this respect, it will be appreciated that the sequence of one or more geometry processing stages may generally include any suitable and desired sequence and number of geometry processing stages, and correspondingly the set of one or more memory pools that are allocated to the sequence of one or more geometry processing stages may comprise any suitable number of memory pools.

Various arrangements would be possible in this regard.

In general, the geometry buffer may be configurable as any suitable and desired number of memory pools and a benefit of the technology described herein is that the particular mechanisms of the technology described herein can generally be applied to any suitable configuration and number of memory pools.

Thus, in some instances, the geometry buffer may be configured as a single memory pool.

In embodiments, however, and typically, it will be configured as a set of plural memory pools, with different memory pools being accessible by different geometry processing stages within the sequence of geometry processing stages.

It will be appreciated that the allocation of memory pools to the geometry processing stages is in embodiments performed in advance, e.g. in software, when initially configuring the graphics processing pipeline. The initial configuration in embodiments also determines the physical size of the geometry buffer in memory, i.e. how much memory should be reserved for the geometry buffer in the external memory system. This in turn may be used to determine the size of the memory pools, e.g. by dividing the memory reserved for the geometry buffer by the number of memory pools that can be (or are) configured.

The graphics processor may thus include a memory manager (unit) containing the appropriate access logic for controlling the graphics processor's access to the geometry buffer in use, according to this configuration.

The particular control of the technology described herein, as described further below, may thus generally be applied to any suitable set of memory pools within the geometry buffer, as desired.

Subject to the particular requirements of the technology described herein, this storage, i.e. the geometry buffer, may reside at any suitable and desired location within the system. In embodiments, however, the geometry buffer is held locally to, and “on chip” with, the graphics processor in use.

This then means that at least some of the (temporary) geometry items (packets) that are produced by the geometry processing stages and that will also be consumed during the initial, geometry processing pass can be, and in embodiments are, held more locally to the graphics processor in use, rather than having to transfer the (temporary) geometry items to/from the memory system.

For instance, in embodiments, the graphics processor comprises, or has access to, a cache system that is operable to transfer data between the graphics processor and an external memory system (e.g. main memory) and the geometry buffer in embodiments resides, in use, within this cache system.

In particular, in embodiments, the graphics processor comprises a cache, e.g., and in embodiments, in the form of a (shared) level 2 (L2) cache, that is provided locally to, and “on chip” with, the graphics processor (although it will be appreciated that multiple levels of caching may be provided, as desired), and the geometry buffer in embodiments resides, in use, within this level 2 (L2) cache.

Providing such local cache storage can then facilitate storing some (and in embodiments all) of the (temporary) geometry items (packets) locally, e.g. “on chip” with the graphics processor in use.

It will be appreciated in this regard that the geometry buffer will generally be backed by the memory system and so some or all of the geometry buffer could in some instances be written out to memory, e.g. in the event of cache overspill.

The technology described herein, however, in embodiments avoids this, so that the geometry buffer that stores the (temporary) geometry items (packets) is held entirely within the cache system in use.

The technology described herein thus in embodiments saves having to write any of the (temporary) geometry items (packets) out to an external memory system. For example, and in embodiments, as will be explained further below, the total (maximum) size of the geometry buffer is configured (and controlled) such that it fully resides within a particular cache (level), e.g. to reduce, and in embodiments avoid, the geometry buffer spilling out to memory.

In this regard, it will be appreciated that there may be a larger number of such (temporary) geometry items (packets) produced during the geometry processing for a given render pass, but these will also be consumed as part of the same geometry processing, and so they will typically have relatively shorter lifetimes during the render pass. Thus, these (temporary) geometry items (packets) do not generally need to written out to memory, and it may be inefficient to do so, as they will typically be consumed shortly after they are produced. Further, preventing these (temporary) geometry items (packets) being written out to the memory system can significantly reduce bandwidth and/or energy consumption, and hence improve the overall graphics processor performance.

Thus, in the graphics processing pipeline that is implemented by the graphics processor according to the technology described herein, respective ones of the geometry processing stages, as part of their respective processing operations, will issue various requests to the memory manager (unit) to allocate respective portions of memory within the geometry buffer for storing the respective geometry items that the geometry processing stages will produce. (Respective ones of the geometry processing stages will also issue requests to the memory manager (unit) to subsequently deallocate portions of memory, when the respective geometry items for which the portions of memory were allocated have been consumed.)

These requests for allocation (or deallocation) of memory are managed by the access logic which controls access to the geometry buffer.

In particular, according to the technology described herein, the access logic is operable and configured to control whether allocations are made in order to manage the active usage of the geometry buffer, e.g., and in embodiments, to (try to) keep the currently active part of the geometry buffer entirely on chip, e.g., within the local (e.g. level 2 (L2)) cache system, as discussed above. In embodiments, therefore, the access logic is operable to control access to the geometry buffer in such a manner that any temporary geometry items that are produced by the sequence of one or more geometry processing stages and then also consumed during the initial, geometry processing pass, and thus that are to be stored within the geometry buffer, are stored entirely within the local cache system, in embodiments without ever being written out to the external memory system.

According to the technology described herein, the geometry buffer thus has a certain ‘permitted active size threshold’, representing the maximum amount of memory that should be concurrently allocated within the geometry buffer in use, i.e. the ‘active’ size of the geometry buffer. This threshold is then use to control the amount of memory that is available to be allocated (and that is allocated) within the geometry buffer, and hence to control the amount of data that is actively stored within the geometry buffer.

The permitted active size threshold for the geometry buffer can therefore be, and in embodiments is, set based on the size of the (L2) cache system, for example, to try to keep the active part of the geometry buffer entirely on chip, as discussed above.

Thus, in embodiments, the graphics processor comprises a cache that is operable to transfer data between the graphics processor and an external memory system, and wherein the permitted active size threshold for the geometry buffer is set based on the size of the cache such that the active part of the geometry buffer can fit entirely within the cache.

That is, the total amount of memory that can be concurrently allocated for storing geometry items across the set of memory pools in use is smaller than the size of the cache in question. For example, in embodiments, the permitted active size threshold for the geometry buffer may thus be set as a certain proportion of the size of the graphics processor's level 2 (L2) cache, such as 25% or 50%.

The permitted active size threshold for the geometry buffer may also be dynamically varied over time, e.g. based on system conditions. For instance, in this respect, as will be discussed further below, the Applicant recognises that it may be desirable to temporarily increase the available size of the geometry buffer in some instances, in particular when it is desired to increase the throughput of the geometry and/or binning processing stages.

Thus, in embodiments, the permitted active size threshold for the geometry buffer is configurable in use to vary the amount of memory that is available to be allocated for storing the geometry items. In embodiments, this is configuration is done as part of the geometry endpoint activation (i.e. when a geometry processing job is initiated). In this way, the permitted active size threshold for the geometry buffer may be changed between render passes, or even between draw calls. In general, however, the permitted active size threshold for the geometry buffer may be varied in any suitable and desired manner, and the technology described herein is generally able to handle any such changes.

Various arrangements are possible in this regard.

In the technology described herein, once the ‘permitted active size threshold’ has been appropriately configured, the access logic that controls access to the geometry buffer (i.e. the access logic within the memory manager) then controls subsequent allocations to the memory pools within the geometry buffer to (try to) keep the active size of the geometry buffer, i.e. the amount of memory that is allocated within the geometry buffer, below the currently configured permitted active size threshold.

In particular, when the access logic receives a request to allocate a respective portion of a memory pool in the set of memory pools for storing a new geometry item produced by the respective geometry processing stage to which the memory pool is allocated, subject to any other conditions that may need to be checked, the access logic is operable and configured to:
determine whether allocating the requested portion of the memory pool would cause the total amount of memory allocated for storing geometry items within the set of memory pools to exceed a permitted active size threshold for the geometry buffer; and
when it is determined that allocating the requested portion of the memory pool would cause the total amount of memory allocated for storing geometry items within the set of memory pools to exceed the permitted size threshold for the geometry buffer, prevent the allocation being made.

To facilitate this, the access logic is further operable and configured to track a total amount of memory that is currently allocated for storing geometry items within the set of memory pools. The determination whether allocating the requested portion of the memory pool would cause the total amount of memory allocated for storing geometry items within the set of memory pools to exceed the permitted active size threshold for the geometry buffer is thus performed based on this tracking.

Thus, the access logic checks whether (or not) this condition is met, and when it is determined that the allocation would cause the total amount of memory allocated for storing geometry items within the set of memory pools to exceed the permitted active size threshold for the geometry buffer, the access logic prevents the allocation being made at that point.

Thus, the allocation is only permitted if this condition is met (although there may also be other conditions that need to be met before the allocation can be made, as will be discussed further below). Otherwise, if at least this condition is not met, the request for allocation is stalled, and the allocation cannot be made until the condition (and any other conditions that need to be satisfied) is met.

This approach then allows the graphics processor to more flexibly distribute the available storage space within the geometry buffer (i.e. so long as the active size of the geometry buffer remains below the permitted active size threshold) between the different memory pools within the geometry buffer.

In particular, the approach described above allows different ones of the memory pools to temporarily use a relatively larger portion of the available storage space, as appropriate based on the current system conditions, whilst still ensuring that the memory pools within the geometry buffer are kept logically separate from each other, such that the memory pools can be assigned to respective, different geometry processing stages. The amount of storage that is available to the different memory pools can therefore be adapted to system conditions, which can therefore improve the overall graphics processor performance and also provide more efficient use of the storage resource (e.g. the cache) within which the geometry buffer resides. Keeping the memory pools logically separate from each other, and backed by separate portions of memory, also helps simplify the memory management operations (e.g. compared to providing a single shared memory pool that is used by all of the geometry processing stages, and which may therefore require more complex memory management, to avoid deadlocks, etc.).

Further this is all done in such a manner to control the amount of memory allocated within the geometry buffer, and hence the active size of the geometry buffer, to remain below permitted active size threshold. This then in embodiments allows all of the geometry items within the geometry buffer to be held in use entirely on chip, e.g., and in embodiments, within the graphics processor's level 2 (L2) cache, until they are consumed.

The technology described herein may therefore provide various benefits compared to other possible approaches.

In embodiments, in addition to the control described above based on the permitted active size threshold for the geometry buffer as a whole, the access logic is also operable to control allocations to the individual memory pools within the geometry buffer based on respective permitted active size thresholds for the respective memory pools. That is, there is in embodiments also configured, for each memory pool within the set of memory pools in the geometry buffer, a respective individual active size threshold, that represents the maximum amount of memory that can be concurrently allocated within that particular memory pool.

In embodiments, the respective active size thresholds for the memory pools within the set of memory pools in the geometry buffer are also configurable in use to vary the relative amount of memory that is available to be allocated to the respective stages to which the memory pools are allocated.

The access logic is thus in embodiments also operable and configured to track, for each memory pool within the set of memory pools into which the geometry buffer is configured, an amount of memory that is currently allocated for storing geometry items within each respective memory pool within the set of memory pools into which the geometry buffer is configured, and to also check that any requested allocations to a given memory pool will not cause the size of that memory pool to exceed the respective active size threshold that has been set for that memory pool.

Thus, when the access logic receives a request to allocate a respective portion of a memory pool in the set of memory pools for storing a new geometry item produced by the respective geometry processing stage to which the memory pool is allocated, the access logic is in embodiments further operable and configured to:
determine whether allocating the requested portion of the memory pool would cause the amount of memory allocated for storing geometry items within the memory pool for which the allocation is being made to exceed a respective active size threshold for the memory pool in question; and
when it is determined that allocating the requested portion of the memory pool would cause the amount of memory allocated for storing geometry items within the memory pool to exceed the active size threshold for the memory pool in question, prevent the allocation being made.

Thus, there are in embodiments (at least) two conditions that are checked by the access logic in order to determine whether an allocation can be made: firstly whether the allocation will cause the total active size of the geometry buffer (i.e. the amount of allocated memory within the geometry buffer as a whole) to exceed the permitted active size threshold for the geometry buffer as a whole, and secondly whether the allocation will cause the active size of the particular memory pool for which the allocation is being made to exceed a respective active size threshold for that particular memory pool.

Thus, in embodiments, if either of these conditions is not met, the access logic prevents the allocation being made. Whereas, only when both conditions are met (at least), does the access logic permit the allocation to be made.

In embodiments, an allocation to a particular memory pool will also (always) be permitted if the amount of memory that is currently allocated for storing geometry items within that particular memory pool is zero.

For example, where there are multiple memory pools, it may be the case that the total amount of memory that is currently allocated in one or more of those memory pools exceeds the permitted active size threshold for the geometry buffer as a whole, but there may be another memory pool for which no memory is currently allocated. In that case, if an allocation is requested into the another memory pool, the above conditions could prevent the allocation being made until space becomes available in the geometry buffer (i.e. because the allocation will cause the total active size of the geometry buffer to exceed the permitted active size threshold for the geometry buffer as a whole).

This could in some cases however result in a potential deadlock situation. In particular, if the allocation cannot be made until a deallocation can be performed elsewhere, but which deallocation in turn depends on the allocation being made, this could result in a deadlock, in which progress cannot be made. This can therefore be avoided by ensuring that an allocation can always be made in any particular memory pool, and this is in embodiments done by always permitting at least one allocation to be made into each of the memory pools defined as part of the current configuration, such that an allocation to a particular memory pool is always successful if the amount of memory that is currently allocated for storing geometry items within that particular memory pool is zero.

More generally in this regard, there may be a certain minimum size threshold associated with each (enabled) memory pool in the set of memory pools in the geometry buffer, and the access logic may be operable to permit allocations to memory pools, as needed, based on the minimum size threshold(s) associated with the memory pools, and this may in embodiments override the conditions described above (that may otherwise prevent the allocation being made).

In other words, when a request to allocate a portion of a memory pool is received, it is in embodiments first checked based on the minimum size threshold whether the allocation should always be permitted, even if this potentially causes the memory pool and/or geometry buffer to exceed a respective active size threshold, prior to then checking whether (or not) performing the allocation may cause the memory pool and/or geometry buffer to exceed the respective active size threshold (and potentially then preventing the allocation being made at that point).

It will be appreciated that these checks may not be performed in strict order, and that the access logic may thus perform all of these checks, but at least in the case that the minimum size threshold check dictates that the allocation should be performed, this then effectively overrides the checks based on the other conditions (that may otherwise prevent the allocation from being made), so that the allocation is in embodiments always permitted is the amount of memory that is currently allocated for storing geometry items within that particular memory pool is less than or equal to the minimum size threshold (e.g. it is zero).

That is, when it is determined that the amount of memory that is currently allocated within that memory pool is less than or equal to the minimum size threshold, the allocation is permitted to be made, even when allocating the requested portion of the memory pool would cause one or more other conditions (that may otherwise prevent the allocation from being made) to not be met.

In some cases, therefore, this may increase the probability of the geometry buffer to spill out to memory, although this should still be rare for typical graphics processing applications.

Thus, in embodiments, when the access logic receives a request to allocate a portion of a memory pool in the set of memory pools for storing a geometry item produced by the respective geometry processing stage to which the memory pool is allocated, the access logic is operable to:
determine whether the amount of memory that is currently allocated within the memory pool is less than or equal to a minimum size threshold associated with the memory pool, and when it is determined that the amount of memory that is currently allocated within that memory pool is less than or equal to the minimum size threshold, (always) permit the allocation to be made,
whereas when it is determined that the amount of memory that is currently allocated within that memory pool is greater than the minimum size threshold, the access logic is operable to control whether (or not) the allocation can be made based on the other conditions discussed above.

Thus, in embodiments, in cases where the amount of memory that is currently allocated within that memory pool is greater than the minimum size threshold (i.e. so long as the allocation is not automatically permitted on this basis), the access logic will then permit/prevent the allocation being made based on the other checks described above.

Thus, when it is determined that the amount of memory that is currently allocated within that memory pool is greater than the minimum size threshold, the access logic is in embodiments operable to then check whether allocating the requested portion of the memory pool would cause the total amount of memory allocated for storing geometry items across the set of memory pools to exceed the permitted active size threshold for the geometry buffer as a whole, and in embodiments to also check whether allocating the requested portion of the memory pool would cause the amount of memory allocated for storing geometry items within the memory pool for which the allocation is being made to exceed a respective active size threshold for the memory pool in question.

Thus, in embodiments, in addition to the control based on the two conditions described above, the access logic performs further control based on the minimum size threshold(s) associated with the memory pools to try to avoid potential deadlock situations. The minimum size threshold(s) for the memory pools may effectively be zero, as discussed above, so that an allocation is always permitted into a memory pool if the amount of memory that is currently allocated in that memory pool is zero, but the minimum size threshold(s) could also take other suitable values, as desired, so that an allocation is always permitted when the amount of memory that is currently allocated in that memory pool is less than some other minimum size threshold. The minimum size thresholds may be configurable in use, and may be configurable on a per memory pool basis, e.g. as part of the geometry endpoint activation. Or, the minimum size thresholds may be fixed for a particular graphics processor implementation.

Various arrangements would be possible in this regard.

If all of the relevant conditions are satisfied for an allocation to be made, the access logic thus determines that the allocation can be made, and (e.g.) passes the allocation request on to the memory system to allocate an appropriate portion of the memory. Once the allocation has been made, a suitable allocation response can then be passed back to the access logic (and also signalled to the geometry processing stage that triggered the allocation request), and the tracking status updated accordingly to reflect the memory allocation.

In the event that the access logic determines that the allocation cannot be made, and thus prevents the allocation being made, the request for allocation should subsequently be re-tried, to see whether the conditions are now met to allow the allocation to be made.

To facilitate this, any failed allocation requests could be suitably held within a buffer associated with the access logic for this purpose.

In general, however, there may be larger numbers of allocation requests, and so in embodiments rather than attempting to buffer the failed allocation requests, in the event that an allocation cannot be made, the access logic returns a suitable signal to the geometry processing stage that requested the allocation to indicate that the memory allocation has failed. At some point, the geometry processing stage may therefore issue another request to perform the same allocation, and this will be processed in the same manner discussed above. For instance, each geometry processing stage may maintain a respective queue of geometry items to be processed/produced, and allocation requests may be triggered for the geometry items within this queue.

Thus, when the access logic prevents an allocation being made, this is in embodiments signalled back to the geometry processing stage that issued the allocation request, and the geometry processing stage is in embodiments operable and configured to subsequently re-issue the allocation request. For instance, as a result of such signalling, the respective geometry item for which the allocation request was made in embodiments remains in the respective queue of geometry items to be processed/produced by that geometry processing stage, and this will trigger another allocation request to be issued for that same geometry item at an appropriate later point.

Various arrangements would be possible in this regard.

It will be appreciated from the above, that the amount of memory that can be (and is) allocated within each memory pool within the geometry buffer (i.e. the active size for each memory pool) will therefore be smaller than the actual amount of storage that has been reserved in memory for the memory pool.

For instance, as discussed above, each memory pool has a certain active size threshold, and allocations can only be made up to this active size threshold. This active size threshold will however be smaller than the actual physical size of the memory pool. The portion of the memory pool that is currently available to be allocated thus effectively defines a window that is the size of the active size threshold. The access logic may therefore store, for each memory pool, suitable head and tail pointers for defining the window of memory that is currently available to be allocated. Thus, in embodiments, the access logic stores, for each memory pool within the set of memory pools in the geometry buffer, a respective head pointer and tail pointer defining a portion of memory corresponding in size to the maximum permitted active size for the memory pool.

At the start of a render pass, therefore, allocations may be made at the start of the memory pool, within a certain window corresponding in size to the active size threshold. At this point, the head pointer defining such window in embodiments corresponds to the base address of the memory pool.

Over time, as portions of memory are deallocated at the start of the window, rather than making the deallocated portion of memory then available for allocation, a correspondingly sized portion of memory is in embodiments made available from the position of the tail pointer for the current window. That is, when a portion of a memory pool in the set of memory pools is deallocated, the access logic is in embodiments configured to make a correspondingly-sized portion of the memory pool starting at the position of the current tail pointer available for allocation. The head and tail pointers are in embodiments then updated accordingly. The effect of this therefore is that there is a ‘rolling’ window corresponding in size to the active size threshold for the memory pool that is effectively moved through the memory pool.

This then means that new allocations of memory are always performed in a deterministic manner, i.e. so that portions of memory will be allocated sequentially moving through the memory pool address range (at least until the end of the memory pool address range is reached, at which point allocations will wrap round to the base address of the memory pool). For instance, even if the active size threshold for the memory pool is changed, so that the effective size of the memory pool is restricted, allocations are still performed within the full memory pool, in the normal manner, and the effective size restriction therefore simply throttles the rate at which new allocations are made, but does not impact where those new allocations will be made within the memory pool.

(In contrast, if the physical size of the memory pool in memory were changed, it will be appreciated that a new allocation could either be made at the start of the memory pool or the end of the memory pool depending on whether the allocation was made before or after the size restriction is implemented.)

In this regard, it will be appreciated that at least in embodiments, the actual memory footprint of the geometry buffer is essentially irrelevant to the graphics processor's performance (so long as the geometry buffer is large enough to contain all of the memory pools in their maximum permitted size configuration), since the access logic is configured to control allocations to the geometry buffer based on the permitted active size threshold(s), as described above, rather than based on the actual size of the memory pool in memory.

The use of the geometry buffer is therefore in embodiments opaque to the external memory system, as it is only the currently active part of the geometry buffer that is stored in the cache system (the level 2 (L2) cache), and the currently active part of the geometry buffer is in embodiments kept below a certain permitted active threshold to keep the geometry buffer entirely within the cache system.

This however means that as requests to deallocate portions of the memory pool are issued, there will be portions of the memory pool that are not actively used. Further, because the active part of the memory pool is defined by a ‘rolling’ window that moves through the memory pool, some of these portions of the memory pool that are not actively used will contain geometry items that were previously allocated (but that have now been deallocated).

As discussed above, the active part of the geometry buffer in embodiments resides fully within the cache system (the level 2 (L2) cache) in use. Therefore, to avoid any such deallocated geometry items being written out to the memory system, when the access logic receives a request to deallocate a portion of a memory pool, the access logic when deallocating the portion of the memory pool in embodiments also invalidates the cache entries associated with the (data within the) portion of the memory pool in question. This then means that the data can be discarded at that point, e.g. so that the data will not then be evicted from the cache system to the memory system as the cache resource is used up.

Thus, in embodiments, when the access logic receives a request to deallocate a portion of memory that is being used to store a particular geometry item, wherein the data for the particular geometry item currently resides in one or more cache entry of a cache (e.g. the level 2 (L2) cache) associated with the graphics processor, the access logic is configured to invalidate the one or more cache entry to prevent the data being written out from the cache.

It will be appreciated that without this invalidation mechanism, there will be lots of deallocated geometry items that would be needlessly written out to memory, which would have a significant bandwidth cost.

Various arrangements possible in this regard.

The approach described above also allows for more seamless re-partitioning and/or re-sizing of the geometry buffer into memory pools.

For instance, as alluded to above, the active size threshold(s) for the memory pools and/or the maximum permitted active size threshold for the geometry buffer as a whole are in embodiments dynamically configurable, and may thus vary over time. Thus, these thresholds may be varied between render passes, or even between draw calls. This could be done, for instance, based on the expected memory requirements for that render pass/draw call, and/or based on the number of memory pools that are enabled for that render pass/draw call (when the memory pools can be selectively enabled/disabled on a per render pass/draw call basis). The active size threshold(s) could however also be varied more dynamically, e.g. within a render pass/draw call. For instance, this could be done based on monitoring current system conditions, in particular to try to control the data flow within the geometry processing stages. For example, the active size threshold for a particular memory pool could be reduced to temporarily throttle the corresponding geometry processing stage to which that memory pool is assigned. This may be appropriate to prevent queuing up excessive numbers of geometry items if there is a bottleneck within the sequence of geometry processing stages.

Various arrangements would be possible in this regard.

In general, therefore, the configuration and sizes of the memory pools within the geometry buffer can be varied over time, and the technology described herein allows such changes to be handled in the same manner described above. That is, the same conditions described above can be applied after any such re-configuration event and used to determine whether or not allocations can be made.

In this regard, it will be appreciated that if the re-configuration is to make a particular memory pool bigger, it should generally be permitted to make new allocations to that particular memory pool, so long as the permitted active size threshold for the geometry buffer as a whole is not exceeded.

On the other hand, if the re-configuration is to make a particular memory pool smaller, the current amount of memory allocated within the memory pool could in some instances be larger than the newly configured active size threshold. In that case, any new allocations to that particular memory pool may be stalled until sufficient space becomes available within the memory pool. Thus, any stall should only be temporary, and will eventually release as portions of the memory pool are deallocated.

It will also be appreciated in this regard that in some instances, due to such re-configuration, the geometry buffer may temporarily exceed the permitted active size threshold. This may then cause all new allocations to stall until this is resolved. Again, however, this should only be temporary, and any performance hit will therefore be relatively localised. In particular, with the approach described above, it is not generally necessary to drain the geometry processing stages of work in order to re-configure the memory pools, as this can be dealt with automatically based on the tracking/conditions described above.

According to the technology described herein, therefore, a suitable set of one or more memory pools can be configured for a particular graphics processing pipeline implementation, e.g. as part of an initial configuration process. Once a set of memory pools has been suitably configured for a particular graphics processing pipeline, each of the memory pools in the set of memory pools would typically then have a fixed physical size within the geometry buffer (and in embodiments this is also the case in the technology described herein). Thus, the memory pools, once initially configured, in embodiments have a fixed physical size in memory, e.g. until/unless the graphics processing pipeline is reconfigured.

However, the amount of memory that is actually available to be allocated within each memory pool is controlled based on various active size thresholds that can be dynamically configured, as described above. These thresholds effectively then control the rate at which new allocations can be made.

This can then improve overall performance, e.g. by allowing greater storage resource to be provided where it is needed, whilst still keeping the active size of the geometry buffer below a desired active size threshold. This also means that the thresholds can easily be varied in use to control the flow/throughput within the geometry processing stages, without having to re-configure the geometry buffer in memory (and potentially therefore drain the geometry processing stages to do this).

The technology described herein thus permits more dynamic re-partitioning of the geometry buffer in use, and at least in embodiments further provides a particularly efficient and low complexity mechanism for doing this, that is managed within the graphics processor (hardware).

Thus, the control is performed by such access logic within the graphics processor, e.g., and in embodiments, without requiring any external (e.g. software) management.

The technology described herein accordingly also extends to the operation of the graphics processor itself in this way.

A further embodiment of the technology described herein comprises a graphics processor that is configured to execute a tile-based graphics processing pipeline in which a render output is generated by performing an initial, “geometry processing” pass and a subsequent, “rendering” pass,
wherein the initial, geometry processing pass of the graphics processing pipeline being executed by the graphics processor comprises:
a sequence of one or more geometry processing stages to perform geometry processing; and
a binning stage to generate data structures for identifying geometry to be processed when rendering respective tiles of a render output being generated, and
wherein the subsequent, rendering pass of the graphics processing pipeline being executed by the graphics processor comprises a rendering stage that renders respective (render output) tiles,
wherein the graphics processor has access to a geometry buffer for storing (temporary) geometry items that are produced by the sequence of one or more geometry processing stages and then consumed during the initial, geometry processing pass, and
the graphics processor further comprising access logic for controlling access to the geometry buffer,
wherein the geometry buffer is configured as a set of memory pools that can be allocated to respective geometry processing stages for storing the geometry items produced thereby, and wherein the access logic is operable and configured to track a total amount of memory that is currently allocated for storing geometry items across the set of memory pools, and
wherein the access logic is operable to, for a request to allocate a respective portion of a memory pool in the set of memory pools for storing a new geometry item produced by the respective geometry processing stage to which the memory pool is allocated:
determine, based on the tracking, whether allocating the requested portion of the memory pool would cause the total amount of memory allocated for storing geometry items across the set of memory pools to exceed a permitted active size threshold for the geometry buffer; and
when it is determined that allocating the requested portion of the memory pool would cause the total amount of memory allocated for storing geometry items across the set of memory pools to exceed the permitted active size threshold for the geometry buffer, prevent the allocation being made.

Another embodiment of the technology described herein comprises a method of operating a graphics processor, wherein the graphics processor is configured to execute a tile-based graphics processing pipeline in which a render output is generated by performing an initial, “geometry processing” pass and a subsequent, “rendering” pass,
wherein the initial, geometry processing pass of the graphics processing pipeline being executed by the graphics processor comprises:
a sequence of one or more geometry processing stages to perform geometry processing; and
a binning stage to generate data structures for identifying geometry to be processed when rendering respective tiles of a render output being generated, and
wherein the subsequent, rendering pass of the graphics processing pipeline being executed by the graphics processor comprises a rendering stage that renders respective (render output) tiles,
wherein the graphics processor has access to a geometry buffer for storing (temporary) geometry items that are produced by the sequence of one or more geometry processing stages and then consumed during the initial, geometry processing pass,
wherein the geometry buffer is configured as a set of memory pools that can be allocated to respective geometry processing stages for storing the geometry items produced thereby, and wherein the method comprises:
tracking a total amount of memory that is currently allocated for storing geometry items across the set of memory pools, and
for a request to allocate a respective portion of a memory pool in the set of memory pools for storing a new geometry item produced by the respective geometry processing stage to which the memory pool is allocated:
determining, based on the tracking, whether allocating the requested portion of the memory pool would cause the total amount of memory allocated for storing geometry items across the set of memory pools to exceed a permitted active size threshold for the geometry buffer; and
when it is determined that allocating the requested portion of the memory pool would cause the total amount of memory allocated for storing geometry items across the set of memory pools to exceed the permitted active size threshold for the geometry buffer, preventing the allocation being made.

As will be appreciated by those skilled in the art, these additional embodiments of the technology described herein relating to the operation of the graphics processor can, and in embodiments do, include any one or more or all of the features of the technology described herein described herein, as appropriate.

Thus, the graphics processor according to these additional embodiments may, and in embodiments does, correspond to the graphics processor described above and may be operated in the same manner.

Likewise, the geometry buffer that the graphics processor can access, as well as the control of the graphics processor's access to that geometry buffer, in embodiments corresponds to those according to the operations described above.

Further, the graphics processor in embodiments comprises a cache system, including level 2 (L2) cache, and the geometry buffer in embodiments resides within such cache system, such that it is held locally to, and on-chip with, the graphics processor (with the access logic performing the same tracking and determinations described above to facilitate this).

As alluded to above, the configuration of the permitted size threshold(s) for the geometry buffer and/or the memory pools within the geometry buffer can be (and generally is) performed based on system conditions, e.g., and in particular, based on the current processing conditions within the graphics processor.

Various arrangements would be possible in this regard.

For instance, the binning stage, when performing the desired binning processing to generate the data structures for identifying geometry to be processed when rendering respective tiles of a render output being generated, will need geometry items to have been suitably produced/processed by the geometry processing stages before the binning processing can be performed, such that the geometry processing stages effectively ‘feed’ the binning stage with geometry items for (binning) processing. The memory pool(s) within the geometry buffer thus effectively queue up geometry items for processing by the binning stage.

Therefore, in order to improve throughput/performance of the binning processing, it may be desirable to have relatively larger amounts of storage available for storing the (temporary) geometry items that are produced by the geometry processing stages. This should then increase the number of geometry items (packets) in-flight at a particular instant, thus reducing instances where the binning stage is waiting for geometry processing to complete.

For example, in an embodiment, as will be discussed further below, the binning processing is performed in a distributed manner, using a plurality of (binning) cores. In that case, as the number of cores that are available to perform the binning processing increases, the amount of storage available for storing the (temporary) geometry items produced by the geometry processing stages may accordingly also desirably be increased to ensure that there are sufficient numbers of geometry items in flight to feed the binning cores.

Thus, if the geometry/binning processing is performance critical, i.e. such that the geometry/binning processing is currently limiting the overall performance of the graphics processing system (in other words, the geometry/binning processing is “exposed”), it may be desirable to have a relatively larger amount of storage available for storing the (temporary) geometry items produced by the geometry processing stages.

In that case, therefore, the maximum permitted active size of the geometry buffer may desirably be increased, at least temporarily (and the technology described herein facilitates this).

That is, if the geometry/binning processing is “exposed”, e.g., and in particular, such that the graphics processor is currently only performing geometry/binning processing (and other processing may be waiting for the geometry/binning processing to complete), it may be beneficial to complete the geometry/binning processing as quickly as possible, and it may therefore be appropriate for the sequence of geometry processing stages to have access to relatively larger (sized) geometry buffer.

In this case, there should also generally be less pressure on the cache system, such that the cache system should be able to efficiently handle a relatively larger geometry buffer, e.g., and in embodiments, without data from other processing causing the geometry buffer to spill out to memory.

The Applicant also recognises, however, that in many graphics processing applications, the graphics processing workload is scheduled such that the geometry/binning processing for a given render pass is interleaved with the rendering/fragment processing for another (e.g. the previous) render pass. That is, most of the time, the geometry/binning processing is not “exposed”, as the graphics processor will also be performing other processing work.

In that case, whilst increasing the number of geometry items in flight may help improve the performance (i.e. speed) of the geometry/binning processing, this can in some situations lead to the overall graphics processing performance being reduced. For example, increasing the number of geometry items in flight may generally result in higher memory bandwidth, and hence increased energy consumption, which may mean that the graphics processor clock speed needs to be reduced. Having more geometry items in flight can also result in longer overall latency, such that the lifetime of the geometry items may be increased. Further, this can reduce caching performance.

Thus, in other cases it may be desired to effectively restrict the active size of the geometry buffer, and this can therefore be done, i.e. by reducing the permitted active size threshold for the geometry buffer.

Similar considerations may apply to the configuration of the size thresholds for the individual memory pools within the geometry buffer. That is, if it is desired, based on system conditions, that the size of a memory pool allocated to a particular geometry processing stage should be increased/decreased, this can be done, and the particular control of the technology described herein can handle this, as described above.

Various arrangements would be possible in this regard.

Subject to the particular requirements of the technology described herein, the graphics processor may otherwise be operable and configured in any suitable manner.

For instance, as mentioned above, the technology described herein relates to tile-based graphics processing in which a render output (e.g. a frame) is subdivided into plural rendering tiles for the purposes of rendering. In that case each rendering tile may and in embodiments does correspond to a respective sub-region of the overall render output (e.g. frame) that is being generated. For example, a rendering tile may correspond to a rectangular (e.g. square) sub-region of the overall render output. The graphics processor is thus in embodiments operable to execute and implement a tile-based graphics processing pipeline.

In particular, the tile-based graphics processing pipeline comprises (in order) a sequence of one or more geometry processing stages, a binning stage, and a rendering stage. When performing tile-based rendering, the geometry processing stages and the binning stage thus together perform the initial geometry processing/binning pass, whereas the rendering stage performs the subsequent deferred rendering pass. It will be appreciated that whilst these different stages are logically separate to one another, the various processing stages may share processing circuitry/circuits, etc., if desired.

The geometry processing that is and can be performed in the technology described herein can comprise any suitable and desired sequence of one or more geometry processing stages that may be performed as part of a graphics processing pipeline.

In an embodiment, the geometry processing comprises one or more of, and in embodiments plural of, the following geometry processing stages: a vertex shader (vertex shading); a tessellation control shader (tessellation control shading); a task shader (task shading); a tessellation shader (tessellation shading); a mesh shader (mesh shading); a tessellation evaluation shader (tessellation evaluation shading); a geometry shader (geometry shading); and a transform feedback shader (transform feedback shading). The geometry processing may comprise one or more of these shader stages, as desired.

The sequence of one or more geometry processing stages is in embodiments implemented and executed as a geometry processing pipeline, comprising the sequence of one or more geometry processing stages in question.

In embodiments, as mentioned above, the geometry processing (prior to the binning stage) operates to generate respective (geometry) “packets” that each store data for geometry to be processed (for the render output in question). Thus, the geometry “items” produced by the sequence of geometry processing stages may, e.g., and in embodiments do, comprise respective (geometry) packets. For example, in an embodiment a (and each) (geometry) packet that the geometry processing generates stores data for a set of one or more primitives (and in embodiments for a set of plural primitives) to be processed (for the render output in question).

Each (geometry) packet may store any suitable and desired data for the geometry (e.g. set of one or more primitives) that it relates to. For example, a (geometry) packet may, and in embodiments does, store appropriate attributes, such as positions and varyings, for a set of (in embodiments plural) vertices for the geometry (e.g. set of primitives) that the packet relates to, for example, and in embodiments, together with a set of identifiers (indices) for the vertices that can be used to determine how the vertices are used for the geometry (e.g. primitives) that the packet relates to. A packet in embodiments also contains connectivity information describing the primitives that the vertices within the packet are generating. A packet may also store attributes and identifiers for the geometry, e.g. primitives, itself, if desired, and/or other, e.g., state, information relating to the geometry that the packet relates to.

Other arrangements would, of course, be possible.

The initial (geometry) packets that are generated by the geometry processing may be created in any suitable and desired manner. For example geometry and/or work items (e.g. vertices) relating to that geometry may be progressively added to a packet, e.g. until a condition for finishing the packet (and, if necessary, starting a new packet), such as a maximum amount of geometry and/or work items for the packet being met, is reached.

In an embodiment, each respective geometry processing stage of the sequence of one or more geometry processing stages for the geometry processing (pipeline) that is being executed, generates a respective geometry packet, and provides that respective geometry packet as an input packet to a next geometry processing stage of the sequence (if any), with that next geometry processing stage of the sequence then processing the input packets that it receives to generate one or more output geometry packets, that are then provided as inputs to a next geometry processing stage of the sequence (if any), and so on.

Thus, in an embodiment, the first stage of the geometry processing, which in embodiments comprises position shading or vertex shading (comprising both position shading and varying shading, for example), acts as an “input packetizer” that generates initial packets storing data for geometry to be processed. These initial geometry packets are then in embodiments appropriately processed by (any) subsequent stages of the geometry processing to generate, for example, modified versions of the initial geometry packets and/or to generate additional geometry packets, as required. For example, a mesh shader may generate multiple packets from a single input (e.g. task shader) packet.

(It will be appreciated here that not all of the geometry processing for packets storing data for geometry to be processed for a render output needs to be performed in advance of and for the binning/tiling stage in a tile-based graphics processing pipeline, but rather some of that processing can, where appropriate, be deferred until the rendering/fragment processing stage of the graphics processing pipeline. Thus, in embodiments some of the geometry processing for packets may be effectively “deferred”, e.g., and in embodiments, until it has been determined that a packet storing data for geometry to be processed for a render output actually applies to a rendering tile.)

Various arrangements are possible in this respect.

Thus, the graphics processor in embodiments comprises a sequence of one or more geometry processing stages to perform geometry processing and to provide respective geometry items, e.g., and in embodiments, in the form of “packets” of geometry, to the binning stage for processing.

The binning stage will in embodiments then receive packets for processing from the geometry processing stages (which packets will have been subject to the appropriate and desired geometry processing within the geometry processing stages). The binning stage should then, and in embodiments does, process the packets it receives for processing to generate one or more data structures that can be used to determine whether (the respective) packets should be processed for respective rendering tiles.

Thus, the binning stage in embodiments generates one or more data structures that can be used to determine whether packets storing data for geometry to be processed should be processed for a rendering tile.

The “binning” data structures that are generated by the binning stage for this purpose can take any suitable and desired form. For example, they could comprise lists of packets to be processed for respective rendering tiles or sets of plural rendering tiles (which packet “tile” lists can then be used to determine which packets apply to a given tile). These “binning” data structures will typically be relatively larger, and will be used during the subsequent, rendering pass, and so these “binning” data structures may, e.g., be, and typically will be, written out by the binning stage to more permanent storage, e.g. to (main) memory (e.g. in contrast to the (temporary) geometry items that are in embodiments stored locally to the graphics processor in the geometry buffer as discussed above).

In an embodiment, the (binning) data structures that can be used to determine whether packets storing data for a set of one or more primitives to be processed should be processed for a rendering tile comprise, in embodiments hierarchies of, bounding boxes that can be used for that purpose. Most in embodiments this comprises both bounding boxes for respective individual packets, together with bounding boxes for respective groups of plural packets (and, if desired, for respective groups of groups of plural packets, and so on, if desired).

In this case to determine packets that should be processed for a rendering tile, the rendering tile can, and will be, compared against the respective bounding boxes to identify those packets that apply to the tile.

The binning stage can generate the data structures to be used to determine which packets should be processed for a rendering tile in any suitable and desired manner. In embodiments it uses an appropriate bounding box for a packet for this purpose. For example, in the case where the binning stage prepares lists of packets to be processed for tiles, a bounding box for a packet can be compared to the tiles' positions to identify which tile(s) the packet applies to. In the case where the binning data structure(s) comprises bounding boxes for packets, the bounding box for a packet can be included in those data structures appropriately.

The bounding box for a packet can be determined in any suitable and desired manner. For example, this could be determined based on performing position shading for vertices for primitives in the packet (where that information is available from the geometry processing that has been performed). Or, the bounding box could be derived using other information, e.g., and in embodiments, from the application for which the graphics processing being performed (application-supplied information), for example, and in embodiments, that defines a bounding volume for the packet and a way to transform the bounding volume to derive a bounding box for the packet. In this case therefore, there will be appropriate (meta)data associated with the packet, in embodiments provided by the application, e.g. that defines a bounding volume for the packet and the way to transform the bounding volume to determine a bounding box for the packet. The binning stage will then use this information to determine a bounding box for the packet in question.

In an embodiment, the binning stage can also or instead, in embodiments also, determine the bounding box for a packet from information that has been generated by a geometry processing stage or stage that has already been executed for the packet (and that precedes the geometry processing stage that is being deferred). This information can comprise any suitable and desired information that can allow a bounding box for a packet to be determined.

For example, in the case of a tessellation shader, the tessellation output may consist of barycentric coordinates (which will be expanded to vertices and primitives in a tessellation evaluation shader). In this case, the tessellation shader may be configured to provide the bounding volume in barycentric coordinates, with the tessellation evaluation shader being configured to transform those coordinates into screen space bounding box coordinates (which will then provide a bounding box for the packet in question).

Other arrangements would, of course, be possible.

The binning stage may also perform any other suitable processing on a geometry packet, as desired, such as appropriate culling operations for the primitives in the geometry packet, e.g., and in embodiments to (try to) cull primitives based on the view frustum and/or the facing direction of the primitives.

The binning stage may be implemented in any suitable and desired manner. For example, in embodiments, the binning stage is implemented by (or comprises) a set of plural processing (binning) cores, but other arrangements would of course be possible.

The end result of the geometry processing/binning stages is thus in embodiments to generate processed (primitive) packets which packets are then included into the appropriate data structure that can be used to determine whether packets should be processed for a rendering tile (and that is then processed by the rendering stage).

The sequence of one or more geometry processing stages and the binning stages are thus together configured to perform the initial geometry processing/binning processing pass of the tile-based rendering scheme.

Once the binning stage has generated the necessary data structure or structures to be used to determine when the packets storing data for geometry to be processed should be processed for a rendering tile for a render output (e.g. draw call) being processed, then the rendering (rendering stage) for the render output in question can be performed.

The rendering will be performed on a tile-by-tile basis (as the graphics processor is executing a tile-based graphics processing pipeline), and so accordingly, the rendering stage will, and in embodiments does, use the binning data structures generated by the binning stage to identify packets to be processed for respective rendering tiles. Thus, for a (and each) rendering tile to be processed for generating the rendering output, the binning data structure(s) generated by the binning stage will be, and are in embodiments, used to identify packets storing data for geometry to be processed for the rendering tile in question.

This can be done in any suitable and desired manner, and should, and in embodiments does, depend upon the nature of the binning data structures that the binning stage has generated. For example, where the binning stage generates lists of packets to be processed for respective rendering tiles or sets of rendering tiles, those lists can be used to identify the packets to be processed for a rendering tile. Where the binning stage generates (hierarchies of) bounding boxes for packets, a rendering tile may be compared to the bounding boxes to determine the packets that need to be processed for the rendering tile.

Correspondingly, the rendering stage in embodiments should, and in embodiments does, comprise an initial process of using the binning data structure(s) generated by the binning stage to identify packets to be processed for rendering tiles (which may comprise identifying packets to be processed for regions of the render output, as will be discussed further below).

The actual rendering process may be performed in any suitable and desired manner, e.g. using any suitable rendering scheme that a tile-based rendering system may normally use. For example, in embodiments the rendering is performed using rasterisation. However, it will be appreciated that the technology described herein is not necessarily limited to rasterisation-based rendering and may generally be used for other types of rendering, including ray tracing or hybrid ray tracing arrangements.

As discussed above, the graphics processor has access to a geometry buffer that is operable and configured to store (temporary) geometry items, e.g. packets of geometry, that are produced by the geometry processing stages and that will also be consumed during the initial, geometry processing pass. Geometry items within the geometry buffer that have been produced by one geometry processing stage may thus be accessed by further processing stages, including later geometry processing stages in the set of geometry processing stages and/or the binning stage, as required, to perform further processing.

However, once the initial, geometry processing pass for a particular render pass has finished, the geometry buffer for that render pass can thus be discarded, and storage space deallocated appropriately so that the geometry buffer can be used for the initial, geometry processing pass for a next render pass.

The particular (temporary) geometry items that are stored within the geometry buffer may be any suitable and desired geometry items (e.g. packets), depending on the configuration of the graphics processing pipeline that is being executed. For example, these could include substantially “complete” processed geometry items (packets) that are then provided to the binning stage for processing, or could be partially processed geometry items (packets) that will undergo further (geometry-related) processing with further stages of the graphics processing pipeline.

Subject to the particular requirements of the technology described herein, the geometry buffer may generally be configured in any suitable manner.

As mentioned above, the geometry buffer is configured as a set of one or more memory pools that can be allocated to the sequence of geometry processing stages, as desired.

In this respect, it will be appreciated that multiple geometry processing stages may have access to a particular memory pool within the geometry buffer. For instance, a given geometry processing stage may be able to allocate space within a memory pool for storing new geometry items, and other geometry processing stages may then be able to access those geometry items from within the memory pool. Another geometry processing stage may then be able to trigger ‘deallocation’ in respect of geometry items, i.e. to free up space within the memory pool for storing new geometry items, once a previously produced geometry item has been used.

In embodiments, as discussed above, the graphics processor comprises a cache that is operable to transfer data between the graphics processor and a memory system (e.g. main memory). The geometry buffer in embodiments resides within this cache, and so is backed by the memory system. However, as discussed above, the size of the geometry buffer is in embodiments configured and controlled such that the geometry buffer resides fully within the cache in use, and is in embodiments therefore not written out to memory.

As mentioned above, the cache is in embodiments a shared cache that will also be used by other processing/processing units within the graphics processor. For example, data for the rendering/fragment processing operations may also be transferred via the same cache in which the geometry buffer resides. The geometry buffer is in embodiments therefore logically separate to any other buffers that may reside in the shared cache, and is in embodiments backed by a different portion of the memory system. Similarly, the geometry buffer is in embodiments separate to the storage that is used for the so-called “intermediate” geometry data that is produced as the end result of the initial, geometry processing pass.

The above describes the main elements and operation of the graphics processor and graphics processing pipeline that are relevant to operation in the manner of the technology described herein.

As will be appreciated by those skilled in the art, the graphics processor can otherwise include and execute, and in embodiments does include and execute, any one or one or more, and in embodiments all, of the processing stages and circuits that graphics processors and graphics processing pipelines may (normally) include.

In an embodiment, the graphics processor comprises, and/or is in communication with a memory system, one or more memories, and/or memory devices that store the data described herein, and/or that store software for performing the processes described herein. The graphics processor may also be in communication with a host microprocessor, and/or with a display for displaying images based on the output of the graphics processor.

The output to be generated may comprise any output that can and is to be generated by the graphics processor and processing pipeline. Thus, it may comprise, for example, a tile to be generated in a tile based graphics processing system, and/or a frame of output fragment data. The technology described herein can be used for all forms of output that a graphics processor and processing pipeline may be used to generate, such as frames for display, render-to-texture outputs, etc. In an embodiment, the output is an output frame, and in embodiments an image.

In an embodiment, the various functions of the technology described herein are carried out on a single graphics processing platform that generates and outputs the (rendered) data that is, e.g., written to a frame buffer for a display device.

The various functions of the technology described herein can be carried out in any desired and suitable manner. For example, unless otherwise indicated, the functions of the technology described herein can be implemented in hardware or software, as desired. Thus, for example, unless otherwise indicated, the various functional elements, stages, etc., of the technology described herein may comprise a suitable processor or processors, controller or controllers, functional units, circuitry, circuits, processing logic, microprocessor arrangements, etc., that are configured to perform the various functions, etc., such as appropriately dedicated hardware elements (processing circuits/circuitry) and/or programmable hardware elements (processing circuits/circuitry) that can be programmed to operate in the desired manner.

It should also be noted here that, as will be appreciated by those skilled in the art, the various functions, etc., of the technology described herein may be duplicated and/or carried out in parallel on a given processor.

Equally, as mentioned above, the various processing stages may share processing circuitry/circuits, etc., if desired.

Furthermore, unless otherwise indicated, any one or more or all of the processing stages of the technology described herein may be embodied as processing stage circuits, e.g., in the form of one or more fixed-function units (hardware) (processing circuits), and/or in the form of programmable processing circuits that can be programmed to perform the desired operation. Equally, any one or more of the processing stages and processing stage circuitry of the technology described herein may be provided as a separate circuit element to any one or more of the other processing stages or processing stage circuits, and/or any one or more or all of the processing stages and processing stage circuits may be at least partially formed of shared processing circuits.

Subject to any hardware necessary to carry out the specific functions discussed above, the graphics processor can otherwise include any one or more or all of the usual functional units, etc., that graphics processors include.

It will also be appreciated by those skilled in the art that all of the described embodiments of the technology described herein can, and, in an embodiment, do, include, as appropriate, any one or more or all of the features described herein.

The methods in accordance with the technology described herein may be implemented at least partially using software e.g. computer programs. It will thus be seen that the technology described herein may in embodiments provide computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc.

The technology described herein also extends to a computer software carrier comprising such software which when used to operate a display controller, or microprocessor system comprising a data processor causes in conjunction with said data processor said controller or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus, in a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible, non-transitory medium, such as a computer readable medium, for example, diskette, CDROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrinkwrapped software, preloaded with a computer system, for example, on a system ROM or fixed disk, or distributed from a server or electronic bulletin board over a network, for example, the Internet or World Wide Web.

Embodiments of the technology described herein will now be described.

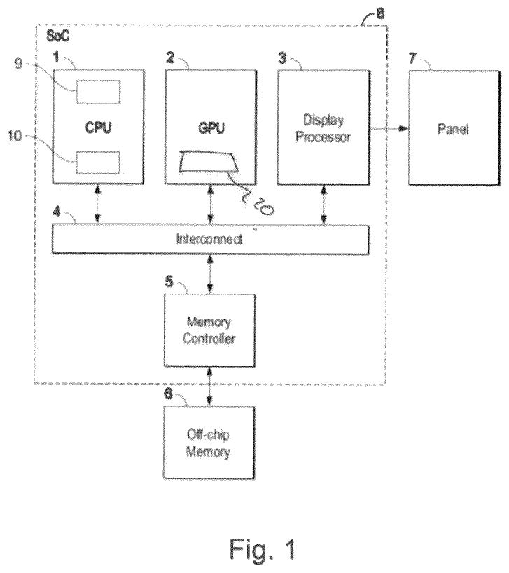

FIG. 1 shows an exemplary system on chip (SoC) graphics processing system 8 that comprises a host processor comprising a central processing unit (CPU) 1, a graphics processor (GPU) 2, a display processor 3, and a memory controller 5. As shown in FIG. 1, these units communicate via an interconnect 4 and have access to off-chip memory 6. In this system, the graphics processor 2 will render frames (images) to be displayed, and the display processor 3 will then provide the frames to a display panel 7 for display.

In use of this system, an application 9 such as a game, executing on one or more host processors (CPUs) 1 will, for example, require the display of frames on the display panel 7. To do this, the application will submit appropriate commands and data to a driver 10 for the graphics processor 2, e.g. that is executing on a CPU 1. The driver 10 will then generate appropriate commands and data to cause the graphics processor 2 to render appropriate frames for display and to store those frames in appropriate frame buffers, e.g. in the main memory 6. The display processor 3 will then read those frames into a buffer for the display from where they are then read out and displayed on the display panel 7 of the display.

The graphics processor 2 may also comprise a suitable cache system 20 that is operable to transfer data between the graphics processor 2 and the off-chip memory 6. This then allows at least some data to be held more locally to the graphics processor 2 rather than always having to fetch that data from the off-chip memory 6, and can hence reduce latency and/or bandwidth, in the normal manner for such graphics processor cache operations.

In the present embodiment, the graphics processor 2 executes a graphics processing pipeline that processes graphics primitives, such as triangles, when generating an output, such as an image for display.

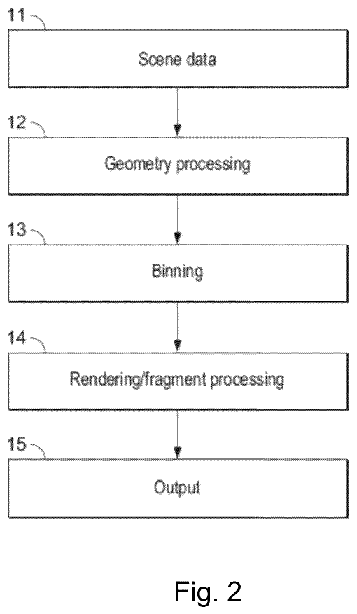

FIG. 2 shows schematically the processing sequence of the graphics processing pipeline executed by the graphics processor 2 when generating an output in the present embodiments.

FIG. 2 shows the main elements and pipeline stages. As will be appreciated by those skilled in the art there may be other elements of the graphics processor and processing pipeline that are not illustrated in FIG. 2. It should also be noted here that FIG. 2 is only schematic, and that, for example, in practice the shown pipeline stages may share significant hardware circuits, even though they are shown schematically as separate stages in FIG. 2. It will also be appreciated that each of the stages, elements and units, etc., of the processing pipeline as shown in FIG. 2 may, unless otherwise indicated, be implemented as desired and will accordingly comprise, e.g., appropriate circuitry, circuits and/or processing logic, etc., for performing the necessary operation and functions.

As shown in FIG. 2, for an output to be generated, a set of, e.g. scene data 11, including, for example, and inter alia, a set of vertices (with each vertex having one or more attributes, such as positions, colours, etc., associated with it), a set of indices referencing the vertices in the set of vertices, and primitive configuration information indicating how the vertex indices are to be assembled into primitives for processing when generating the output, is provided to the graphics processor, for example, and in embodiments, by storing it in the memory 6 from where it can then be read by the graphics processor 2.

This scene data may be provided by the application (and/or the driver in response to commands from the application) that requires the output to be generated, and may, for example, comprise the complete set of vertices, indices, etc., for the output in question, or, e.g., respective different sets of vertices, sets of indices, etc., e.g. for respective draw calls to be processed for the output in question. Other arrangements would, of course, be possible.

There is then a geometry processing stage or stages 12, which performs appropriate geometry processing of and for the scene data to generate the data that will then be required for rendering the output. This geometry processing 12 can comprise any suitable and desired geometry processing that may be performed as part of a graphics processing pipeline.

In the present embodiments, this geometry processing comprises at least performing vertex processing (vertex shading) of attributes for vertices to be used for primitives for the render output being generated. In particular, appropriate vertex position shading is performed to transform the positions for the vertices from the, e.g. “model” space in which they are initially defined, to the, e.g., “screen”, space that the output is being generated in. In embodiments, the vertex shading also comprises generating and/or processing other, non-position attributes of vertices (varyings/varying shading). It would also be possible for some or all the varying shading to be deferred from the geometry processing and, for example, to be triggered at the binning or rendering stages instead, if desired.

As well as appropriate vertex shading, the geometry processing may comprise any other form of geometry processing that is desired, such as one or more of tessellation shading, transform feedback shading, mesh shading, or task shading. This geometry shading may also generate and/or process attributes for vertices, and/or it may process and generate attributes for primitives as well.

Once the desired geometry processing has been performed, there is then, in the present embodiments, as shown in FIG. 2, a binning/tiling stage 13. (It is assumed in this regard that the graphics processor 2 in the present embodiments is a tile-based graphics processor and so generates respective output tiles of an overall output (e.g. frame) to be generated separately to each other, with the set of tiles for the overall output then being appropriately combined to provide the final, overall output.)

The binning process operates to generate appropriate data structures for determining which primitives need to be processed for respective rendering tiles of the output being generated. For example, it may sort the primitives into appropriate primitive lists, which indicate the primitives to be processed for respective tiles or sets of tiles. Alternatively, it may generate other data structures, such as hierarchies of bounding boxes, that can then be used at the rendering/fragment processing stage to identify those primitives that need to be processed for a respective tile.

The binning/tiling process 13 may also cull primitives that are not visible (e.g. that fall outside the view frustum, and/or based on the facing direction of the primitives).

As part of the geometry processing and/or the binning/tiling operation the primitives to be processed will be “assembled”. The primitives will, as discussed above, be assembled from a set of indices referencing vertices in a set of vertices for the render output processing being performed, based on primitive configuration information indicating how the vertex indices are to be assembled into primitives for processing when generating the render output.

Such primitive assembly may be performed as part of and at an appropriate stage of the geometry processing and/or as part of the binning/tiling processing, as desired. There may also, if desired, be two (or more) “primitive assembly” operations. For example, an initial primitive assembly operation could be performed to identify those vertices that will actually be used for the render output being generated before performing any vertex shading of the vertices, but with there then being a later primitive assembly stage that provides a sequence of assembled primitives for the binning/tiling stage.

Once the binning/tiling process has generated the necessary data structures for identifying the primitives to be processed for respective tiles of the render output, the primitives can then be and are then subjected to appropriate rendering/fragment processing 14. This operation is performed in the present embodiments on a tile-by-tile basis, using the data structures generated by the tiling/binning process 13 to identify those primitives that need to be processed for a respective tile.

The rendering/fragment processing can comprise any suitable and desired rendering and fragment processing operations that may be performed. Thus, it may comprise, for example, first rasterising primitives to be processed for a tile to fragments, and then processing those fragments accordingly (e.g., and in embodiments, by performing appropriate fragment shading of the fragments). The rendering/fragment processing may also or instead comprise performing ray tracing operations, such as performing the rendering by tracing rays for respective fragments representing respective sets of one or more sampling positions of the output being generated. Hybrid ray tracing operations would also be possible, if desired.

The output of the rendering/fragment processing (the rendered fragments) is written to a tile buffer (not shown). Once the processing for the tile in question has been completed, then the tile will be written to an output data array in memory 6, and the next tile processed, and so on, until the complete output data array 15 has been generated. The process will then move on to the next output data array (e.g. frame), and so on.

The output data array may typically be an image for a frame intended for display on a display device, such as a screen or printer, but may also, for example, comprise intermediate render data intended for use in later rendering passes (also known as a “render to texture” output), or for deferred rendering, or for hybrid ray tracing, etc.

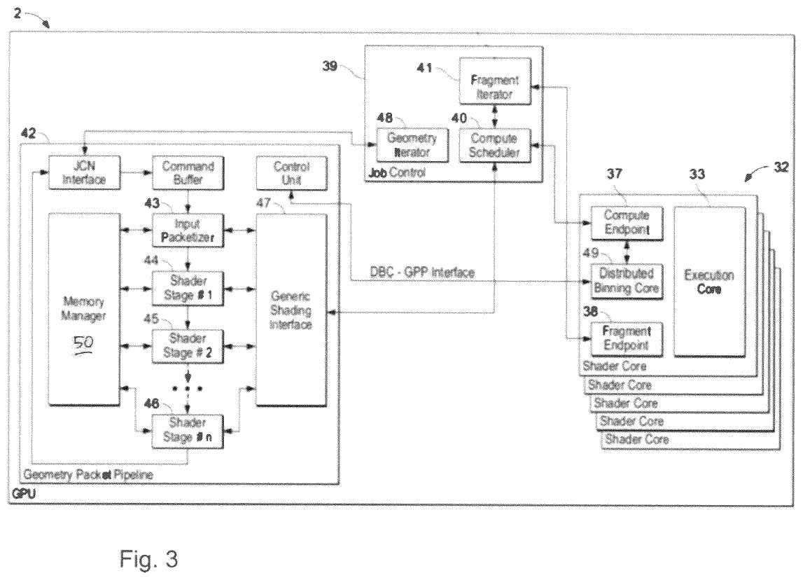

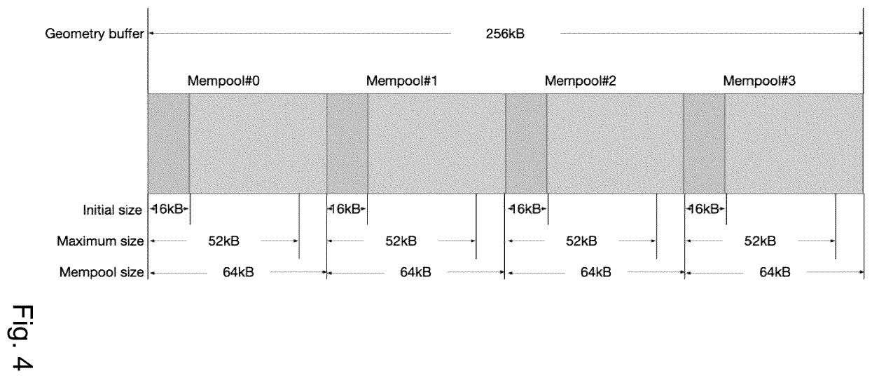

FIG. 3 shows an embodiment of a graphics processor (GPU) 2 that can execute a graphics processing pipeline of the form shown in FIG. 2, and that can be operated in the manner of the technology described herein.

As shown in FIG. 3, the graphics processor 2 comprises a plurality of processing (shader) cores 32 which are each operable to execute (shader) programs to perform processing operations. As shown in FIG. 3 each shader core 32 to facilitate this comprises a programmable execution unit (execution core) 33 that is operable to execute program instructions to perform processing operations.

In the present embodiments, the shader cores 32 are operable to execute both “compute” shader programs (to perform so-called compute shading) and fragment shader operations. Thus, as shown in FIG. 3, each shader core 32 comprises an appropriate compute endpoint 37 and fragment endpoint 38 that act as the control interface for performing compute shading and fragment processing, respectively, and that will, for example, and in embodiments, trigger the execution core 33 to execute the appropriate compute shading or fragment shading tasks, as required.

As shown in FIG. 3, the compute endpoint 37 and fragment endpoint 38 receive appropriate processing tasks from a job control unit 39 of the graphics processor 2, which job control unit 39 includes an appropriate compute scheduler 40 and fragment iterator 41 for distributing processing jobs that the job controller 39 receives as appropriate processing jobs to the shader cores 32.

As discussed above, when performing graphics processing, there will typically be an initial geometry processing stage that determines the vertex and other data that is necessary for generating the graphics processing output in question, which will then be followed by a rendering/fragment processing stage for processing (rendering) that geometry.

In the present embodiments, the geometry processing is performed, as shown in FIG. 3, by a geometry packet pipeline 42 of the graphics processor 2. This geometry packet pipeline is operable to trigger the performance of one or more “geometry” shader stages (which shader stages themselves will be executed by the shader cores 32, under the control of the geometry packet pipeline 42).

For example, as shown in FIG. 3, the geometry packet pipeline 42 comprises an input packetizer 43 that can trigger position shading and vertex shading by the shader cores 32. It also includes further shader stage circuits 44, 45, 46 that are operable to trigger compute shaders for performing geometry processing, such as task shaders, mesh shaders, tessellation shaders, etc. (which again will be executed by the shader cores 32).

As shown in FIG. 3, the geometry packet pipeline 42 has an appropriate interface 47 to the compute scheduler 40 of the job control unit 39, via which it can control and trigger the performance of appropriate geometry shading operations by the shader cores 32.

The overall operation of the geometry packet pipeline 42 is controlled by the job control unit 39 (by a geometry iterator 48 of the job control unit 39) which distributes the appropriate geometry processing jobs and tasks to the geometry packet pipeline 42.

The graphics processor 2 of FIG. 3 is configured to perform rendering in a tile-based manner (as discussed above). To facilitate this, as shown in FIG. 3, each shader core 32 also includes a distributed binning core 49 that is operable to generate appropriate data structures for determining which primitives need to be processed for respective rendering tiles of the output being generated.

In the present embodiments, the distributed binning cores 49 generate hierarchies of bounding boxes for primitives and primitive packets (that contain primitives to be rendered) (which are then used at the rendering/fragment processing stage to identify those primitives that need to be processed for a respective tile).

The distributed binning cores 49 may also cull primitives that are not visible (e.g. that fall outside the view frustum, and/or based on the facing direction of the primitives).

The distributed binning cores 49 can operate in any suitable and desired manner for this purpose.

The distributed binning cores 49 of the shader cores 32 may trigger vertex shading, such as varying shading, as part of their operation (e.g. where varying shading was not performed by the input packetizer as part of the input packetizer 43 operation).

In the present embodiments, the rendering/fragment processing is performed by executing appropriate fragment processing operations on a shader core 32 under the control of the fragment endpoint 38. To facilitate this, the fragment endpoint 38 of each shader core is operable to trigger appropriate fragment shader operation by a shader core.

As will be appreciated from the above, in operation of the present embodiments, the geometry packet pipeline 42 that performs the geometry processing will generate appropriate geometry data, such as (transformed) vertex positions, vertex varyings, and primitive attributes, which data will then be used, for example, by the binning/tiling processing and rendering/fragment processing of the later stages of the graphics processing pipeline.

In the present embodiments, the geometry packet pipeline 42 operates to generate respective geometry packets containing the data that it generates. In the present embodiments, those geometry packets are then processed by the distributed binning cores 49 to generate corresponding primitive packets, which primitive packets are then used by the fragment processing (fragment shaders) 52.

Thus, in the present embodiments, the geometry packet pipeline 42 will generate geometry packets that store attributes for vertices and primitives, which geometry packets will then be read and used by the distributed binning cores 49.

Correspondingly, the distributed binning cores 49 will generate appropriate primitive packets storing attributes for vertices and primitives, which primitive packets will then be read and used by the fragment processing 38.

Other arrangements would of course be possible. For example, rather than the geometry packet pipeline 42 generating geometry packets that are then read and used by the distributed binning cores 49 as shown in FIG. 3, the geometry packet pipeline 42 could interface and provide geometry packets to a (dedicated) tiling unit that then performs more traditional tiling operations, e.g. in the normal (serialized) manner for tile-based graphics processing, using the geometry packets.

Thus, in the present embodiments, the geometry packet pipeline 42 will generate geometry packets that store attributes for vertices and primitives, which geometry packets will then be read and used by the distributed binning cores 49. This so-called “intermediate” geometry data will then be used by the binning/tiling processing and rendering/fragment processing of the later stages of the graphics processing pipeline and so generally needs to be stored for the duration of the render pass (and this is therefore done).

As part of the geometry processing, however, the respective stages within the geometry packet pipeline 42 will also produce various “temporary” geometry packets that are produced within a particular stage of the geometry packet pipeline 42 and which will then be consumed by a later stage within the geometry packet pipeline 42. These temporary geometry packets are therefore relatively shorter-lived, and only need to be stored temporarily, until they have been consumed by the geometry processing. To facilitate this, the geometry packet pipeline 42 will be associated with suitable storage, i.e. a geometry buffer, for holding the temporary geometry data that is produced by the geometry packet pipeline 42 but that will also be consumed by the geometry packet pipeline 42.

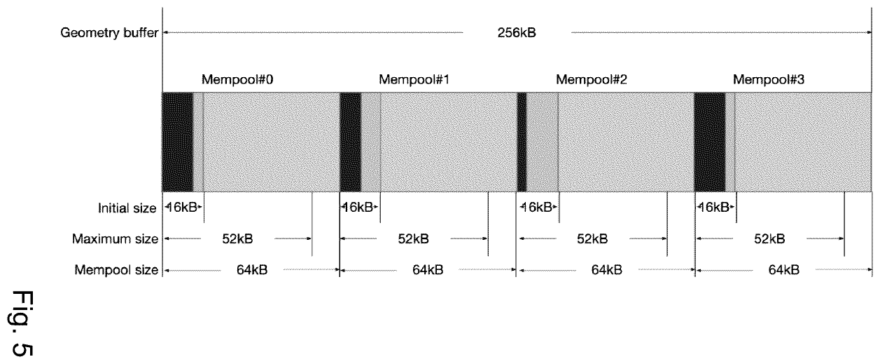

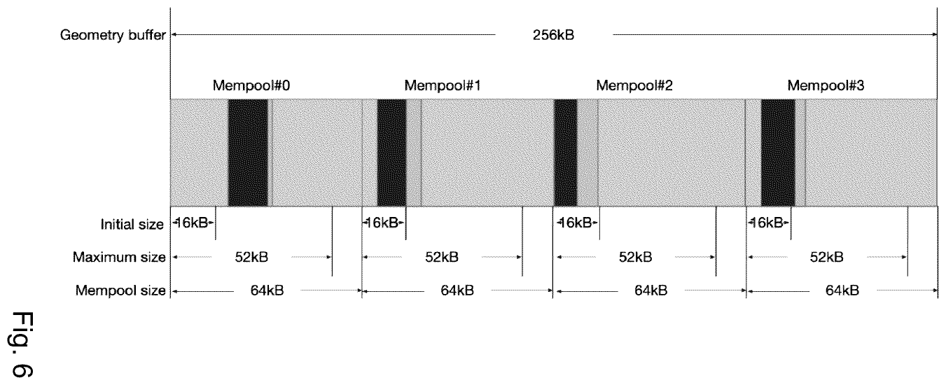

In the present embodiments, this storage, i.e. the geometry buffer, is configured as a set of memory pools, as shown in FIG. 4. For instance, in the example shown in FIG. 4, the geometry buffer is divided into four separate memory pools. In general, however, it will be appreciated that the geometry buffer may be divided into any suitable number of one or more memory pools, as desired, and as will be explained further below, a benefit of the technology described herein is that the geometry buffer can be flexibly configured and re-configured over time, e.g. on a draw call by draw call basis, without necessarily having to drain the geometry packet pipeline 42.

These memory pools can then be assigned to, and used by, different stages within the geometry packet pipeline 42. For instance, a first stage within the geometry packet pipeline 42 may be operable to allocate portions of mempool #0 for storing the packets produced by that first stage. A second, later stage within the geometry packet pipeline 42 that consumes the packets produced by that first stage may then be able to trigger deallocations of those portions of memory.

As shown in FIG. 3, the geometry packet pipeline 42 thus includes a memory manager 50 that contains access logic for controlling access to the set of memory pools into which the geometry buffer is configured.

When the geometry iterator 48 issues a geometry processing job to the geometry packet pipeline 42, the respective stages within the geometry packet pipeline 42 will thus message the memory manager 50 to request the memory manager 50 to allocate portions of the respective memory pools assigned to those stages for storing the packets produced by those stages.

Correspondingly, as packets are consumed, respective stages within the geometry packet pipeline 42 may message the memory manager 50 to request the memory manager 50 to deallocate those portions of the memory pools that were allocated for storing those packets, so that the space is made available to be allocated for new packets.

In the example shown in FIG. 4, the total size of the geometry buffer that is backed by memory is 256 kB. This therefore represents the amount of external memory that is reserved for the geometry buffer, and can be set for instance as part of the initial software configuration. This is then equally divided by the number of memory pools, such that in this example, where the geometry buffer is configured as four separate memory pools, each memory pool is backed by 64 kB of memory. Each memory pool therefore has a memory footprint of 64 kB.

As shown in FIG. 4, each memory pool also has a maximum size of 52 kB which represents the maximum permitted size for the memory pool in use. This also defines the maximum permitted size for the geometry buffer as a whole, which in this example is therefore 208 kB (i.e. 4*52 kB). These maximum sizes can generally be set as desired, so long as the geometry buffer is large enough to hold all of the memory pools in their maximum size configuration.

In the present embodiments, the memory manager 50 is operable and configured to control allocations to the geometry buffer such that the active size of the geometry buffer is kept below a permitted size threshold, in particular so that the geometry buffer can be entirely held locally to, and on chip with, the graphics processor 2 in use. For example, the size of the geometry buffer is in embodiments controlled so that the geometry buffer is held entirely within a level 2 (L2) cache of the graphics processor's cache system 20 in use.

According to the present embodiments, the memory pools have a dynamic active size (with a predefined minimum size (threshold) to guarantee at least one allocation can always be made). The combined total of the active sizes for all of the memory pools thus equals the amount of storage that is occupied in the level 2 (L2) cache by the geometry buffer, and in the present embodiments this combined total is kept below a predefined maximum permitted size threshold for the geometry buffer, to thereby keep the geometry buffer entirely within the level 2 (L2) cache, without spilling any data to the off-chip memory 6.

Thus, although the memory footprint of the geometry buffer may be larger than the storage that is available within the level 2 (L2) cache, the size of the geometry buffer that is backed by memory does not have a direct impact on the amount of data stored in the level 2 (L2) cache as only actively used memory will be stored in the level 2 (L2) cache, and the amount of actively used memory is controlled to try to keep the geometry buffer within the level 2 (L2) cache.

To facilitate this, the following configuration state may be defined:
Implementation defined configuration:
   Maximum number of memory pools (‘num_mempools’)
Geometry endpoint configuration:
   Maximum size of active data within each memory pool (‘max_active_size’)
   Minimum memory pool size
      To prevent any deadlock situations, all memory pools should have a minimum size (threshold) that guarantees at least one allocation.
   Geometry buffer (pointer and size)
      The size of the geometry buffer must be at least large enough to hold all of the configured memory pools in their maximum size configuration (num_mempools*max_active_size)
Per render pass configuration:
   For each memory pool:
      Memory pool enabled (or not) (‘mempool_enable’)
      Memory pool initial size (‘mempool_initial_size’)

Thus, for the example shown in FIG. 4, the implementation supports (up to) four separate memory pools.

When activating the geometry endpoint (i.e. geometry iterator 48 in FIG. 3), the maximum size of each memory pool, and hence of the geometry buffer as a whole (i.e. how much level 2 (L2) cache storage can be used) is set, and optionally also the minimum memory pool size (alternatively this could be fixed for a particular implementation).

The geometry buffer is then configured appropriately with a base address and a size of at least 256 kB.

In the present embodiments, for each render pass, it can then be configured which memory pools are enabled and the initial size of each memory pool. In other embodiments, this could be configured per draw call.

In use, the memory manager 50 then tracks the following dynamic state:
Per memory pool:
   Current size of the memory pool (‘mempool_current_size’)
   Current active usage of the memory pool (‘mempool_active_size’)
   Head and tail pointers
Total active usage (i.e. the sum of the current active usage for all memory pools) (‘total_active_size’)

When the memory manager 50 has received the configuration state as part of the geometry endpoint activation, the memory manager 50 will then reserve memory for the memory pools based on this configuration state.

Thus, each memory pool will get a base address that is defined by:
<geometry buffer base address>*max_active_size*<mempool ID>
and the head and tail pointers and total_active_size will be reset (as there is at this point no active memory usage).

At the beginning of a render pass, the mempool_enable and mempool_initial_size state parameters are captured. The value for mempool_current_size is then set equal to mempool_initial_size, and the render pass can be started.

FIG. 4 thus shows the layout of the memory pools in the geometry buffer just before the first render pass is started. As noted above, each memory pool is backed by 64 kB of memory, but has an initial memory pool size set to 16 kB. At this point, there is therefore 16 kB of available free memory for every memory pool.

When the different stages within the geometry packet pipeline 42 send allocation requests to the memory manager 50, the memory manager 50 will check that at least the following expressions are true before responding to the request:
1) mempool_active_size+<allocation size> is less than mempool_current_size;
2) total_active_size+<allocation size> is less than max_active_size.

If and once the expressions are both true, the memory manager 50 sends the allocation request to memory, and a respective portion of the memory pool in question is then allocated for storing a new geometry packet. The relevant state, i.e. the mempool_active_size and total_active_size, is then updated accordingly to reflect that this portion has been allocated.

Note that allocations are not limited to the first mempool_current_size of the memory pool, but will wrap around at the end of the allocated space for the memory pool. FIG. 5 thus shows a snapshot of the memory pools a short time after starting the render pass. The dark area in FIG. 5 shows the memory that has been allocated.

Over time, as the packets are consumed, the stages within the geometry packet pipeline 42 will send request to the memory manager 50 to deallocate the portion of memory that was previously allocated for storing that packet. When the memory manager 50 receives a deallocation request from a pipeline stage, in the present embodiments, the memory manager 50 issues a range invalidate transaction that invalidate the cache entries associated with the packet that is being deallocated (in embodiments without reading the data). This range invalidate transaction then prevents the deallocated packet being unnecessarily written out to the off-chip memory 6. The memory can then be deallocated appropriately, and the relevant state, i.e. the mempool_active_size and total_active_size, reduced accordingly to reflect this.

As the memory manager 50 receives deallocation requests it will therefore free up memory. Rather than marking the deallocated memory as free, however, a correspondingly-sized portion of memory is made available at the end of the current active range of memory, i.e. starting at the current tail pointer. The head and tail pointers can then be updated accordingly so that there is effectively a window having a size equal to the mempool_current_size that is moved through the memory pool. This is shown, for example, in FIG. 6, which is a snapshot of the geometry buffer some time later. In this way, the full memory pool is used, but the rate at which allocations are made is controlled/throttled by the size of this window.

The above approach thus allows the active part of the geometry buffer, i.e. the space within the level 2 (L2) cache, to be flexibly shared between the different memory pools within the geometry buffer. Thus, if one stage within the geometry packet pipeline 42 is particularly busy, the memory pool assigned to that stage can take a relatively larger portion of the active part of the geometry buffer, and the system can therefore dynamically adapt to system conditions, resulting in improved performance and more efficient use of the level 2 (L2) cache.

The above approach also allows for more seamless transitions in the case that the memory pool partitioning changes. For instance, when the memory pool partitioning changes, either due to new render pass/draw call configuration, or a dynamic partition change in use, the mempool_current_size will be updated. Any allocations received after this point must therefore comply with the two expressions discussed above.

In the case where the mempool_current_size for a memory pool is decreased to a value smaller than the current mempool_active_size, further allocations to that memory pool are therefore not possible until all previous allocations have been deallocated and the mempool_active_size is reduce to be less than the new mempool_current_size. This means that for a short period the memory pool may contain more data than should be allowed (i.e. according to the newly configured mempool_current_size). Since the total_active_size should also not exceed the max_active_size, allocations to other memory pools may also stall until this is resolved, as the second condition may evaluate to false. However, this should only be temporary, and it is not generally necessary to drain the geometry packet pipeline 42, so that any performance impact is relatively limited.

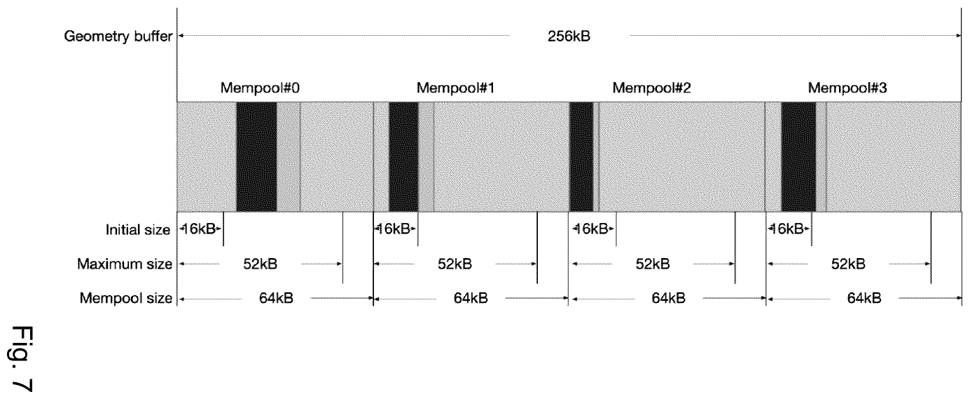

FIG. 7 shows the state of the memory pools within the geometry buffer after re-partitioning. In particular, in this example, the re-partitioning is to decrease the size of mempool #2 (i.e. to set the mempool_current_size for mempool #2 to a lower value), whereas the size of mempool #0 is increased by a corresponding amount. In this example, since mempool #2 at this point is currently using less storage than available, the reduction in size does not have any impact on the flow. The re-partitioning can therefore happen instantly and the extra storage is immediately available for mempool #0.

On the other hand, for the case where the reduction of mempool #2 is greater than the free memory in this memory pool (i.e. the current mempool_active_size for mempool #2 is greater than the newly configured mempool_current_size), no further allocations can be performed in mempool #2 until enough memory has been deallocated in the memory pool so that the first expression above evaluates to true. Allocations in any of the other memory pools can happen as normal, so long as the first and second expressions above both evaluate to true.

Another special case is when one of the memory pools is disabled between render passes or draw calls. In this case, no further allocations are possible for this mempool. Allocations in the other memory pools can still happen, however, with the same restrictions as above. Thus, if a memory pool is going to be disabled, the memory manager 50 must ensure that all allocations from the previous render pass/draw call have completed before disabling the memory pool. This means that it may therefore be necessary to stall a new draw call. Otherwise, in cases where a render pass/draw call reduces the size of a memory pool, stalling is not generally required, and there can be a relatively seamless transition. (There may however be other reasons that stalling may be beneficial, e.g. to avoid reducing a mempool used by the previous draw call too early.)

Thus, to give an example, all four memory pools may be set to mempool_current_size=16 kB. If all memory pools are fully allocated, the mempool_active_size for each memory pool is 16 kB and the total_active_size is 64 kB, which is equal to max_active_size. If at this point, the partitioning is changed so mempool #0 becomes 24 kB and mempool #3 becomes 8 kB, allocations to any memory pool will stall as total_active_size will exceed max_active_size.

A deallocation of 1 kB in mempool #1 causes active size for that pool to be reduced, as well for the total active size. Allocations of 1 kB or less can now complete, but still with the restrictions described above. Thus, an allocation to mempool #3 will not be possible since mempool_active_size is larger than mempool_current_size. An allocation to mempool #2 will also not be possible since the resulting mempool_active_size will be larger than mempool_current_size. An allocation to either mempool #1 or mempool #0 will however succeed.

Note that in the case of a 1 kB allocation for mempool #0, further allocations to either mempool #0 or mempool #1 are not possible as the total_active_size will exceed max_active_size.

For a short period, therefore, allocations are limited due to total_active_size exceeding max_active_size. However, once deallocations for mempool #3 brings mempool_active_size for that mempool below the new mempool_current_size, any further allocations will only be limited by the “mempool_active_size+<allocation size> is less than mempool_current_size” expression.

With the framework described above, it is also possible to perform more dynamic re-partitioning of the geometry buffer, in which the portioning of the geometry buffer into memory pools can change during a draw call or render pass. For instance, new memory pool sizes can generally be defined at any point of time. If the new partitioning reduces the size of a memory pool that is not fully utilized, re-partitioning can be done without any performance hit, in the same manner described above. Similarly, reducing the memory pool size below the currently used active size might mean allocations stall, as described above, but this should only be temporary.

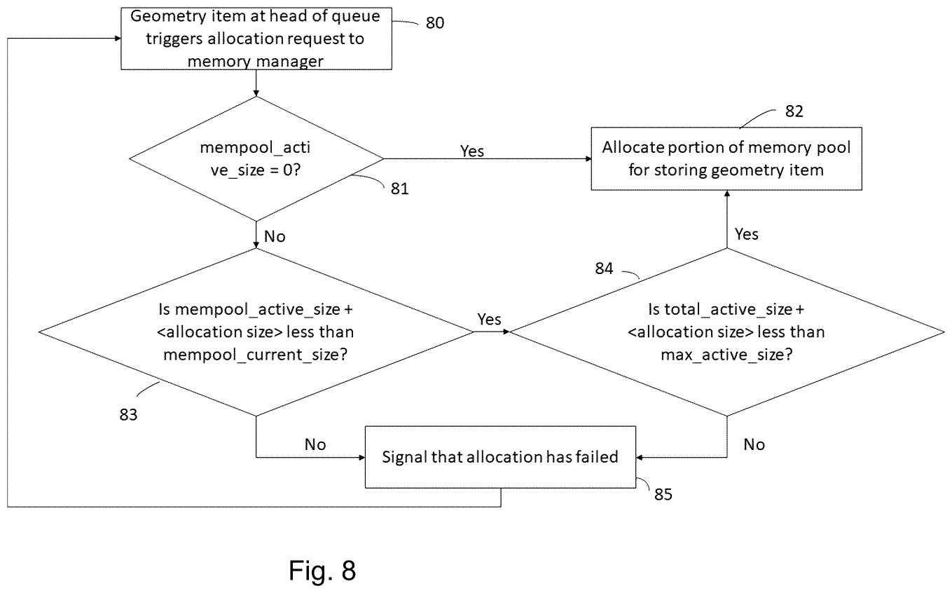

FIG. 8 is a flow chart illustrating the memory management operation when allocating portions of memory.

As indicated above, a given geometry processing stage within the geometry packet pipeline 42 may be operable to produce certain packets of geometry that will then be consumed by a later stage. The geometry processing stage may thus maintain a queue of such packets that are to be produced/processed. In order to do this, the geometry processing stage will need to trigger an appropriate allocation of memory in the respective memory pool for that geometry processing stage for storing the packet data.

As shown in FIG. 8, a packet at the head of the queue may thus trigger an allocation request to the memory manager 50 (step 80). The request will specify an amount of memory that is to be allocated within a memory pool, i.e. the <allocation size>.

On receiving this request, the memory manager 50 will first check whether the mempool_active_size for the memory pool in question is zero (step 81). In the present embodiments, if the mempool_active_size for the memory pool in question is zero (step 81—yes), the allocation request is always permitted, and so the memory manager 50 will in this case then allocate the requested portion of memory for storing the geometry packet (step 82). This then ensures that at least one allocation can always be made, so that progress is guaranteed.

Although in this example the check is whether the mempool_active_size for the memory pool in question is zero it will be appreciated that in general this check could be against any suitable minimum size threshold that has been specified for the memory pool in question and various arrangements would be possible in this regard. Similarly, in some cases, if there is no possibility for deadlocks, or some other exceptional mechanism is provided to handle this specific situation, this check may be omitted.

Various arrangements would be possible in this regard.

So long as the mempool_active_size for the memory pool in question is other than zero (step 81—no), which will typically be the case, the memory manager 50 is then operable to check at least the two conditions, as described above, to control the effective, active size of the geometry buffer.

Thus, it is first checked (at step 83), whether (or not) the “mempool_active_size+<allocation size> is less than mempool_current_size” expression is true. So long as this is true, it is then checked (at step 84), whether (or not) the “total_active_size+<allocation size> is less than max_active_size” expression is true. If both expressions are true, the memory manager 50 then allocates the requested portion of memory for storing the geometry packet. This is then signalled back to the geometry processing stage within the geometry packet pipeline 42 to indicate that allocation has been successful, and the packet is then processed/produced accordingly.

The next packet in the queue can then be processed accordingly, in the same manner, and so on.

On the other hand, if either of the expressions (in step 83 or step 84) evaluate as false, it is then signalled back to the geometry processing stage within the geometry packet pipeline 42 that the allocation has failed (step 85). The packet in question may therefore remain at the head of the queue and will eventually trigger another allocation request (step 80), by which point the restrictions may have been released.

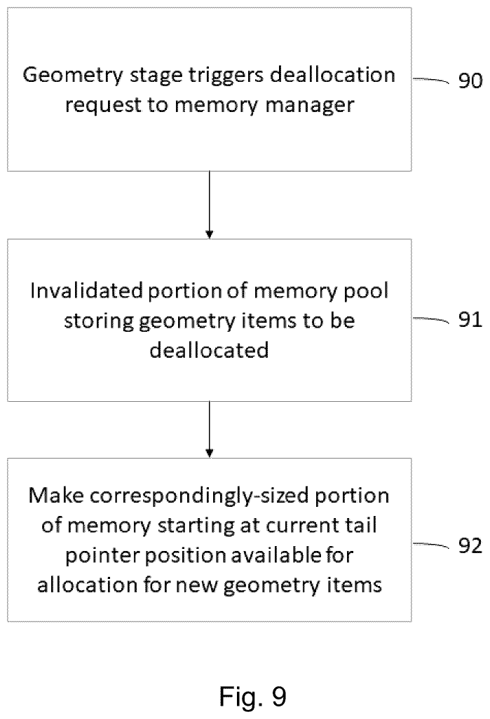

FIG. 9 is a flow chart illustrating the corresponding memory management operation when deallocating portions of memory.

As shown in FIG. 9, a given geometry processing stage within the geometry packet pipeline 42 may trigger a deallocation request to the memory manager 50 in respect of a particular geometry packet (step 90). As discussed above, as part of the deallocation process, the memory manager 50 invalidates the portion of memory that is storing the geometry packet to be deallocated (step 91) and makes a correspondingly-sized portion of memory starting at the current tail pointer for the memory pool in question available for allocation for storing new geometry items (step 92).

Various other arrangements would be possible.

Thus, it will be appreciated that the technology described herein, at least in embodiments, allows for improved graphics processing performance when executing a tile-based graphics processing pipeline in which space within a geometry buffer that is configured as a set of memory pools for storing temporary geometry data that is both produced and consumed by the initial, geometry processing pass can be flexibly distributed between the different memory pools, e.g. depending on the current system conditions.

Various arrangements would be possible in this regard.

For instance, although for ease of explanation the present embodiments are described with reference to a set of four memory pools, in general the geometry buffer may be configured into any suitable set of one or more memory pools that are accessible by the different stages within the geometry packet pipeline 42 and the particular control described above may in that case be applied similarly.

The foregoing detailed description has been presented for the purposes of illustration and description. It is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein described herein, in various embodiments and with various modifications as are suited to the particular use contemplated. It is intended that the scope be defined by the claims appended hereto.

1. A graphics processor that is configured to execute a tile-based graphics processing pipeline in which a render output is generated by performing an initial, geometry processing pass and a subsequent, rendering pass,
wherein the initial, geometry processing pass of the graphics processing pipeline being executed by the graphics processor comprises:
a sequence of one or more geometry processing stages to perform geometry processing; and
a binning stage to generate data structures for identifying geometry to be processed when rendering respective tiles of a render output being generated, and
wherein the subsequent, rendering pass of the graphics processing pipeline being executed by the graphics processor comprises a rendering stage that renders respective tiles,
wherein the graphics processor has access to a geometry buffer for storing geometry items that are produced by the sequence of one or more geometry processing stages and then consumed during the initial, geometry processing pass, and
the graphics processor further comprising access logic for controlling access to the geometry buffer,
wherein the geometry buffer is configured as a set of memory pools that can be allocated to respective geometry processing stages for storing the geometry items produced thereby, and wherein the access logic is operable and configured to track a total amount of memory that is currently allocated for storing geometry items across the set of memory pools, and
wherein the access logic is operable to, for a request to allocate a portion of a memory pool in the set of memory pools for storing a geometry item produced by the respective geometry processing stage to which the memory pool is allocated:
determine, based on the tracking, whether allocating the requested portion of the memory pool would cause the total amount of memory allocated for storing geometry items across the set of memory pools to exceed a permitted active size threshold for the geometry buffer; and
when it is determined that allocating the requested portion of the memory pool would cause the total amount of memory allocated for storing geometry items across the set of memory pools to exceed the permitted active size threshold for the geometry buffer, prevent the allocation being made.

2. The graphics processor of claim 1, wherein the graphics processor comprises a cache that is operable to transfer data between the graphics processor and an external memory system, and wherein the permitted active size threshold for the geometry buffer is set based on the size of the cache such that the active part of the geometry buffer can fit entirely within the cache.

3. The graphics processor of claim 1, wherein the permitted active size threshold for the geometry buffer is configurable in use to vary the amount of memory that is available to be allocated for storing the geometry items.

4. The graphics processor of claim 1, wherein the access logic is also operable and configured to track, for the respective memory pools within the set of memory pools into which the geometry buffer is configured, an amount of storage that is currently allocated for storing geometry items,
the access logic being further operable to, for a request to allocate a respective portion of a memory pool in the set of memory pools for storing a new geometry item produced by the respective geometry processing stage to which the memory pool is allocated:
determine whether allocating the requested portion of the memory pool would cause the amount of storage allocated for storing geometry items within the memory pool for which the allocation is being made to exceed a respective active size threshold for the memory pool in question; and
when it is determined that allocating the requested portion of the memory pool would cause the amount of storage allocated for storing geometry items within the memory pool to exceed the active size threshold for the memory pool in question, prevent the allocation being made.

5. The graphics processor of claim 4, wherein the respective active size thresholds for the memory pools within the set of memory pools in the geometry buffer are configurable in use to vary the relative amount of memory that is available to be allocated to the respective stages to which the memory pools are allocated.

6. The graphics processor of claim 1, wherein the access logic stores, for respective memory pools within the set of memory pools in the geometry buffer, a respective head pointer and tail pointer defining a portion of memory corresponding in size to the maximum permitted active size for the memory pool.

7. The graphics processor of claim 6, wherein when a portion of a memory pool in the set of memory pools is deallocated, the access logic is configured to make a correspondingly-sized portion of the memory pool starting at the position of the current tail pointer available for allocation, and update the head and tail pointers accordingly.

8. The graphics processor of claim 1, wherein when the access logic receives a request to deallocate a portion of memory that is being used to store a particular geometry item, wherein the data for the particular geometry item currently resides in one or more cache entry of a cache associated with the graphics processor, the access logic is configured to invalidate the one or more cache entry to prevent the data being written out from the cache.

9. The graphics processor of claim 1, wherein when the access logic receives a request to allocate a portion of a memory pool in the set of memory pools for storing a geometry item produced by the respective geometry processing stage to which the memory pool is allocated, the access logic is operable to:
determine whether the amount of memory that is currently allocated within the memory pool is less than or equal to a minimum size threshold associated with the memory pool, and when it is determined that the amount of memory that is currently allocated within that memory pool is less than or equal to the minimum size threshold, permit the allocation to be made,
whereas when it is determined that the amount of memory that is currently allocated within that memory pool is greater than the minimum size threshold, the access logic is operable to control whether the allocation can be made based on the determination whether allocating the requested portion of the memory pool would cause the total amount of memory allocated for storing geometry items across the set of memory pools to exceed the permitted active size threshold for the geometry buffer.

10. The graphics processor of claim 1, wherein when the access logic prevents an allocation being made, this is signalled back to the geometry processing stage that issued the allocation request, and wherein the geometry processing stage is operable and configured to subsequently re-issue the allocation request.

11. A method of operating a graphics processor, wherein the graphics processor is configured to execute a tile-based graphics processing pipeline in which a render output is generated by performing an initial, geometry processing pass and a subsequent, rendering pass,
wherein the initial, geometry processing pass of the graphics processing pipeline being executed by the graphics processor comprises:
a sequence of one or more geometry processing stages to perform geometry processing; and
a binning stage to generate data structures for identifying geometry to be processed when rendering respective tiles of a render output being generated, and
wherein the subsequent, rendering pass of the graphics processing pipeline being executed by the graphics processor comprises a rendering stage that renders respective tiles,
wherein the graphics processor has access to a geometry buffer for storing geometry items that are produced by the sequence of one or more geometry processing stages and then consumed during the initial, geometry processing pass,
wherein the geometry buffer is configured as a set of memory pools that can be allocated to respective geometry processing stages for storing the geometry items produced thereby, and wherein the method comprises:
tracking a total amount of memory that is currently allocated for storing geometry items across the set of memory pools, and
for a request to allocate a respective portion of a memory pool in the set of memory pools for storing a new geometry item produced by the respective geometry processing stage to which the memory pool is allocated:
determining, based on the tracking, whether allocating the requested portion of the memory pool would cause the total amount of memory allocated for storing geometry items across the set of memory pools to exceed a permitted active size threshold for the geometry buffer; and
when it is determined that allocating the requested portion of the memory pool would cause the total amount of memory allocated for storing geometry items across the set of memory pools to exceed the permitted active size threshold for the geometry buffer, preventing the allocation being made.

12. The method of claim 11, wherein the graphics processor comprises a cache that is operable to transfer data between the graphics processor and an external memory system, and wherein the permitted active size threshold for the geometry buffer is set based on the size of the cache such that the active part of the geometry buffer can fit entirely within the cache.

13. The method of claim 11, comprising configuring the permitted active size threshold for the geometry buffer in use to vary the amount of memory that is available to be allocated for storing the geometry items.

14. The method of claim 11, comprising:
tracking, for respective memory pools within the set of memory pools into which the geometry buffer is configured, an amount of storage that is currently allocated for storing geometry items;
determining, for the request to allocate the respective portion of a memory pool in the set of memory pools, whether allocating the requested portion of the memory pool would cause the amount of storage allocated for storing geometry items within the memory pool for which the allocation is being made to exceed a respective active size threshold for the memory pool in question; and
when it is determined that allocating the requested portion of the memory pool would cause the amount of storage allocated for storing geometry items within the memory pool to exceed the active size threshold for the memory pool in question, preventing the allocation being made.

15. The method of claim 14, comprising configuring the respective active size thresholds for the memory pools within the set of memory pools in the geometry buffer in use to vary the relative amount of memory that is available to be allocated to the respective stages to which the memory pools are allocated.

16. The method of claim 11, comprising storing, for a memory pool within the set of memory pools in the geometry buffer, a respective head pointer and tail pointer defining a portion of memory corresponding in size to the maximum permitted active size for the memory pool, and the method further comprising:
when a portion of the memory pool is deallocated:
making a correspondingly-sized portion of the memory pool starting at the position of the current tail pointer available for allocation; and
updating the head and tail pointers accordingly.

17. The method of claim 11, comprising:
when a request is received to deallocate a portion of memory that is being used to store a particular geometry item, wherein the data for the particular geometry item currently resides in one or more cache entry of a cache associated with the graphics processor:
invalidating the one or more cache entry to prevent the data being written out from the cache.

18. The method of claim 11, comprising:
when a request to allocate a portion of a memory pool in the set of memory pools for storing a geometry item produced by the respective geometry processing stage to which the memory pool is allocated is received:
determining whether the amount of memory that is currently allocated within the memory pool is less than or equal to a minimum size threshold associated with the memory pool, and when it is determined that the amount of memory that is currently allocated within that memory pool is less than or equal to the minimum size threshold, permitting the allocation to be made, even when allocating the requested portion of the memory pool would cause the total amount of memory allocated for storing geometry items across the set of memory pools to exceed the permitted active size threshold for the geometry buffer.

19. The method of claim 11, wherein when an allocation is prevented being made, the method comprises:
signalling back to the geometry processing stage that issued the allocation request that the allocation request has failed; and
the geometry processing stage subsequently re-issuing the allocation request.

20. A non-transitory computer readable medium storing instructions that when executed by one or more processor will cause the one or more processor to perform a method of operating a graphics processor, wherein the graphics processor is configured to execute a tile-based graphics processing pipeline in which a render output is generated by performing an initial, geometry processing pass and a subsequent, rendering pass,
wherein the initial, geometry processing pass of the graphics processing pipeline being executed by the graphics processor comprises:
a sequence of one or more geometry processing stages to perform geometry processing; and
a binning stage to generate data structures for identifying geometry to be processed when rendering respective tiles of a render output being generated, and
wherein the subsequent, rendering pass of the graphics processing pipeline being executed by the graphics processor comprises a rendering stage that renders respective tiles,
wherein the graphics processor has access to a geometry buffer for storing geometry items that are produced by the sequence of one or more geometry processing stages and then consumed during the initial, geometry processing pass,
wherein the geometry buffer is configured as a set of memory pools that can be allocated to respective geometry processing stages for storing the geometry items produced thereby, and wherein the method comprises:
tracking a total amount of memory that is currently allocated for storing geometry items across the set of memory pools, and
for a request to allocate a respective portion of a memory pool in the set of memory pools for storing a new geometry item produced by the respective geometry processing stage to which the memory pool is allocated:
determining, based on the tracking, whether allocating the requested portion of the memory pool would cause the total amount of memory allocated for storing geometry items across the set of memory pools to exceed a permitted active size threshold for the geometry buffer; and
when it is determined that allocating the requested portion of the memory pool would cause the total amount of memory allocated for storing geometry items across the set of memory pools to exceed the permitted active size threshold for the geometry buffer, preventing the allocation being made.
